(19) United States
(12) Patent Application Publication
(10) Pub. No.: US 2012/0155610 A1
(43) Pub. Date: Jun. 21, 2012

(54) RADIOGRAPHIC IMAGE GENERATION METHOD AND RADIOGRAPHIC IMAGING APPARATUS

(75) Inventors: Dai MURAKOSHI, Kanagawa-ken (JP); Hiroyasu ISHII, Kanagawa-ken (JP)

(73) Assignee: FUJIFILM CORPORATION, Tokyo (JP)

(21) Appl. No.: 13/333,289

(22) Filed: Dec. 21, 2011

(30) Foreign Application Priority Data
Dec. 21, 2010 (JP) 2010-284168
Dec. 19, 2011 (JP) 2011-277010

(51) Int. Cl. G01N 23/04

(52) U.S. Cl. 378/62

(57) ABSTRACT

A radiographic imaging apparatus includes: a first grating having a periodically-arranged grating structure and allowing radiation to pass therethrough to form a first periodic pattern image; a second grating having a periodically-arranged grating structure to receive the first periodic pattern image and form a second periodic pattern image; a radiographic image detector to detect the second periodic pattern image; a correction data storing unit to separately store detector correction data used to correct for characteristics of the radiographic image detector and grating correction data used to correct for characteristics of the first and second gratings; a correction data updating unit to update the detector correction data and the grating correction data independently from each other; and an image generation unit to generate an image based on the updated detector correction data and grating correction data and the second periodic pattern image.

### BACKGROUND OF THE INVENTION

1. Field of the Invention

The present invention relates to a radiographic image generation method and a radiographic imaging apparatus using gratings, and in particular to a radiographic image generation method and a radiographic imaging apparatus wherein calibration of gratings and a radiographic image detector is conducted.

2. Description of the Related Art

X-rays have a nature that they attenuate depending on the atomic number of an element forming a substance and the density and thickness of the substance. Because of this nature, X-rays are used as a probe to investigate the interior of a subject. Imaging systems using X-rays have widely been used in the fields of medical diagnosis, nondestructive testing, etc.

With a typical X-ray imaging system, a subject is placed between an X-ray source, which emits an X-ray, and an X-ray image detector, which detects an X-ray image, to take a transmission image of the subject. In this case, each X-ray emitted from the X-ray source toward the X-ray image detector attenuates (is absorbed) by an amount depending on a difference of characteristics (such as the atomic number, density and thickness) of substances forming the subject present in the path from the X-ray source to the X-ray image detector before the X-ray enters the X-ray image detector. As a result, an X-ray transmission image of the subject is detected and imaged by the X-ray image detector. As examples of such an X-ray image detector, a combination of an X-ray intensifying screen and a film, a photostimulable phosphor, and a flat panel detector (FPD) using a semiconductor circuit are widely used.

However, the smaller the atomic number of an element forming a substance, the lower the X-ray absorbing capability of the substance. Therefore, there is only a small difference of the X-ray absorbing capability between soft biological tissues or soft materials, and it is difficult to obtain a sufficient contrast of an image as the X-ray transmission image. For example, articular cartilages forming a joint of a human body and synovial fluids around the cartilages are composed mostly of water, and there is only a small difference of the X-ray absorption therebetween. It is therefore difficult to obtain an image with sufficient contrast.

In recent years, X-ray phase-contrast imaging for obtaining a phase contrast image based on phase variation of X-rays due to differences between refractive indexes of a subject, in place of the intensity variation of X-rays due to differences between absorption coefficients of a subject, have been studied. With this X-ray phase-contrast imaging using the phase difference, a high contrast image can be obtained even in the case where a subject is a substance having low X-ray absorbing capability.

As an example of such X-ray phase-contrast imaging systems, an X-ray phase-contrast imaging apparatus has been proposed, wherein two gratings including a first grating and a second grating are arranged parallel to each other at a predetermined interval, a self image of the first grating is formed at a position of the second grating based on the Talbot interference effect by the first grating, and the intensity of the self image of the first grating is modulated with the second grating to provide an X-ray phase contrast image.

On the other hand, various types of radiographic imaging cassettes, which have a radiographic image detector and other components contained in a compact housing, have been proposed. Such radiographic imaging cassettes are relatively thin and of a portable size, and thus are convenient for handling. Further, the X-ray imaging cassettes having various sizes and shapes are available depending on the size and type of a subject, and the X-ray imaging cassettes are adapted to be removably mounted on the imaging apparatus depending on conditions of the subject. Therefore, it is considered to use such cassettes with the above-described X-ray phase-contrast imaging apparatus.

In addition, the first and second gratings for use with the X-ray phase-contrast imaging apparatuses are also available in various sizes depending on the size of a subject, etc. Therefore, it is also considered to provide the first and second gratings which are adapted to be removably mounted on the apparatus so that they can be replaced depending on the use, similarly to the radiographic image detectors.

In order to obtain a good image with the X-ray imaging apparatuses, it is necessary to carry out correction with respect to the radiographic image detector using correction data depending on the variation of the individual characteristics of the detector. Characteristics of the radiographic image detector to be corrected for may include conventionally known characteristics, such as variations of offset, sensitivity, linearity, etc., and defective pixel, residual image characteristics, etc.

With respect to the X-ray phase-contrast imaging apparatuses, it is further necessary to correct a phase contrast image with correction data depending on the variation of the characteristics of the first and second gratings, in addition to the above-described correction for the characteristics of the radiographic image detector necessary for the general X-ray imaging apparatuses.

Characteristics of the gratings to be corrected for may include, for example, in-plane variation of grating pitch, relative positional displacement between the first and second gratings, defect of the gratings due to void or dust, etc. If these characteristics are not corrected for appropriately, some artifact is introduced into the resulting phase contrast image. That is, with respect to the above-described X-ray phase-contrast imaging apparatuses, it is necessary to conduct calibration to obtain the correction data with respect to the radiographic image detector and calibration to obtain the correction data with respect to the first and second gratings each time the radiographic image detector or the first and second gratings is/are removed and attached (replaced).

However, if the whole calibration is conducted each time the radiographic image detector or the first and second gratings is/are removed and attached, it takes a very long time to finish the calibrations before imaging can be carried out.

In order to address this problem, it may be considered, as a solution, that pieces of correction data about individual radiographic image detectors and individual first and second gratings used are obtained in advance, and necessary pieces of the correction data are selected depending on the actually used combination of the radiographic image detector and the first and second gratings, thereby eliminating need of conducting the calibration each time the radiographic image detector or the first and second gratings is/are removed and attached. With respect to the X-ray phase-contrast imaging apparatuses, however, it is necessary to detect a small change of a signal of each pixel with good S/N, and this requires positional accuracy on the order of pixel size also for the correction data. Therefore, it is difficult to obtain a good phase contrast image with the above-described solution in the case where the radiographic image detector or the first and second gratings is/are removed and attached.

It should be noted that the above-described problem and a solution thereof are not taught or suggested in WO 2008-102598.

With respect to the X-ray phase-contrast imaging apparatuses, the characteristics to be corrected include those classifiable into items attributed only to the characteristics of the first and second gratings and independent from the characteristics of the radiographic image detector, and items attributed only to the characteristics of the radiographic image detector and independent from the characteristics of the first and second gratings. Therefore, for example, in a case where only the radiographic imaging cassette is replaced and the first and second gratings are not replaced, it is necessary to conduct the calibration for correction for the characteristics of the radiographic image detector, but it is not necessary to conduct the calibration for correction for the characteristics of the first and second gratings. In contrast, in a case where only the first and second gratings are replaced and the radiographic imaging cassette is not replaced, it is necessary to conduct the calibration for correction for the characteristics of the first and second gratings, but it is not necessary to conduct the calibration for correction for the characteristics of the radiographic image detector.

### SUMMARY OF THE INVENTION

In view of the above-described circumstances, the present invention is directed to providing a radiographic image generation method and a radiographic imaging apparatus wherein calibration is simplified to reduce a time taken for imaging.

An aspect of the radiographic imaging apparatus of the invention includes: a first grating having a periodically arranged grating structure and allowing radiation emitted from a radiation source to pass therethrough to form a first periodic pattern image; a second grating having a periodically arranged grating structure to receive the first periodic pattern image and form a second periodic pattern image; a radiographic image detector to detect the second periodic pattern image formed by the second grating; a correction data storing unit to separately store detector correction data used to correct for characteristics of the radiographic image detector and grating correction data used to correct for characteristics of the first and second gratings; a correction data updating unit to update the detector correction data and the grating correction data stored in the correction data storing unit independently from each other; and an image generation unit to generate an image based on the detector correction data and the grating correction data updated by the correction data updating unit and the second periodic pattern image.

In the radiographic imaging apparatus of the invention, the radiographic image detector may be adapted to be removable, the apparatus may further include a detector removal/attachment detection unit to detect removal and attachment of the radiographic image detector, and the correction data updating unit may update the detector correction data when removal and attachment of the radiographic image detector are detected.

In the apparatus of the invention, the first and second gratings may be adapted to be removable, the apparatus may further include a grating removal/attachment detection unit to detect removal and attachment of the first and second gratings, and the correction data updating unit may update the grating correction data when removal and attachment of the first and second gratings are detected.

In the apparatus of the invention, the radiographic image detector and the first and second gratings may be adapted to be removable, the apparatus may further include a detector removal/attachment detection unit to detect removal and attachment of the radiographic image detector and a grating removal/attachment detection unit to detect removal and attachment of the first and second gratings, wherein, in a case where removal and attachment of only the radiographic image detector among the radiographic image detector and the first and second gratings are detected, the correction data updating unit may update only the detector correction data among the detector correction data and the grating correction data, and in a case where removal and attachment of only the first and second gratings among the radiographic image detector and the first and second gratings are detected, the correction data updating unit may update only the grating correction data among the detector correction data and the grating correction data.

The apparatus of the invention may further include a moving mechanism to move the radiographic image detector in directions of relative movement toward and away from a subject, wherein the correction data updating unit may update the grating correction data when the radiographic image detector is moved by the moving mechanism.

In the apparatus of the invention, the radiographic image detector and the first and second gratings may be adapted to be removable, the apparatus may further include a detector removal/attachment detection unit to detect removal and attachment of the radiographic image detector, a grating removal/attachment detection unit to detect removal and attachment of the first and second gratings, and a moving mechanism to move the radiographic image detector in directions of relative movement toward and away from a subject, wherein: in a case where removal and attachment of only the first and second gratings among the radiographic image detector and the first and second gratings are detected, the correction data updating unit may update only the grating correction data among the detector correction data and the grating correction data; in a case where removal and attachment of only the radiographic image detector among the radiographic image detector and the first and second gratings are detected and the radiographic image detector is not moved by the moving mechanism, the correction data updating unit may update only the detector correction data among the detector correction data and the grating correction data; and in a case where removal and attachment of only the radiographic image detector among the radiographic image detector and the first and second gratings are detected and the radiographic image detector is moved by the moving mechanism, the correction data updating unit may update both the detector correction data and the grating correction data.

In the apparatus of the invention, the detector correction data may include at least one of offset correction data, sensitivity correction data and defective pixel correction data with respect to the radiographic image detector.

In the apparatus of the invention, the grating correction data may be based on the second periodic pattern image detected by the radiographic image detector in a state where no subject is placed.

In the apparatus of the invention, the grating correction data may be based on the second periodic pattern image subjected to offset correction with respect to the radiographic image detector.

In the apparatus of the invention, the grating correction data may be based on the second periodic pattern image subjected to sensitivity correction with respect to the radiographic image detector.

In the apparatus of the invention, the grating correction data may include defect position information of the first and second gratings.

The apparatus of the invention may further include a scanning mechanism to move at least one of the first grating and the second grating in a direction orthogonal to a direction in which the one of the gratings extends, wherein the image generation unit may apply correction using the detector correction data to a plurality of radiographic image signals representing the second periodic pattern images detected by the radiographic image detector for different positions of the one of the gratings moved by the scanning mechanism, and may generate a phase contrast image with using the corrected radiographic image signals and the grating correction data.

In the apparatus of the invention, the first grating and the second grating may be positioned such that a direction in which the first periodic pattern image of the first grating extends is inclined relative to a direction in which the second grating extends, and the image generation unit may apply correction using the detector correction data to a radiographic image signal detected by the radiographic image detector when the radiation is applied to a subject, and may generate a phase contrast image with using the corrected radiographic image signal and the grating correction data.

In the apparatus of the invention, the image generation unit may obtain radiographic image signals read out from different groups of pixel lines as radiographic image signals of different fringe images based on a radiographic image signal detected by the radiographic image detector, and may generate the phase contrast image based on the obtained radiographic image signals of the fringe images.

In the apparatus of the invention, the image generation unit may apply a Fourier transform to a radiographic image signal detected by the radiographic image detector when the radiation is applied to a subject, and may generate a phase contrast image based on a result of the Fourier transform.

An aspect of the radiographic image generation method of the invention is a radiographic image generation method of generating a radiographic image of a subject for use with a radiographic phase-contrast imaging apparatus including: a first grating having a periodically arranged grating structure and allowing radiation emitted from a radiation source to pass therethrough to form a first periodic pattern image; a second grating having a periodically arranged grating structure to receive the first periodic pattern image and form a second periodic pattern image; and a radiographic image detector to detect the second periodic pattern image formed by the second grating, the method including: separately storing detector correction data used to correct for characteristics of the radiographic image detector and grating correction data used to correct for characteristics of the first and second gratings; updating the detector correction data and the grating correction data independently from each other; and generating an image based on the updated detector correction data and grating correction data and the second periodic pattern image.

The term “removable” herein refers not only to a configuration where a member can be attached and removed, but also to a configuration where the member is retractable from a normal mounted state thereof by changing the position of the member with the member remaining attached.

According to the radiographic image generation method and the radiographic imaging apparatus of the invention, the detector correction data used to correct for characteristics of the radiographic image detector and the grating correction data used to correct for characteristics of the first and second gratings are separately stored so that the detector correction data and the grating correction data are updated independently from each other. Therefore, for example, in the case where only the radiographic image detector is removed and attached, only the detector correction data is updated, and in the case where only the first and second gratings are removed and attached, only the grating correction data is updated. In this manner, simplification of calibration is achieved, thereby reducing a time taken for the calibration before imaging can be carried out.

In the case where the radiographic imaging apparatus of the invention carries out magnification imaging by moving the radiographic image detector in directions of relative movement toward and away from a subject to change the magnification factor, the detector correction data, which is not particularly altered by the movement of the radiographic image detector, is not updated, and only the grating correction data, which is altered by the movement of the radiographic image detector, is updated. Also in this case, simplification of the calibration is achieved, thereby reducing a time taken for the calibration before imaging can be carried out.

### BRIEF DESCRIPTION OF THE DRAWINGS

FIG. 1 is a schematic configuration diagram illustrating a breast imaging and display system employing one embodiment of a radiographic imaging apparatus of the present invention,

FIG. 2 is a schematic diagram illustrating a radiation source, first and second gratings, and a radiographic image detector extracted from the breast imaging apparatus shown in FIG. 1,

FIG. 3 is a plan view of the radiation source, the first and second gratings, and the radiographic image detector shown in FIG. 2,

FIG. 4 is a diagram illustrating the schematic structure of the first grating,

FIG. 5 is a diagram illustrating the schematic structure of the second grating,

FIG. 6 is a block diagram illustrating the internal configuration of a computer in the breast imaging and display system shown in FIG. 1,

FIG. 7 is a schematic diagram illustrating one example of offset correction data with respect to the radiographic image detector,

FIG. 8 is a schematic diagram illustrating one example of sensitivity correction data with respect to the radiographic image detector,

FIG. 9 is a diagram showing a relationship among an image Dx for generating sensitivity correction data, an image Dg for generating grid correction data before sensitivity correction, and an image Dp for generating grid correction data after sensitivity correction,

FIG. 10 is a schematic diagram illustrating one example of the images Dp(k=0 to M−1) for generating grid correction data obtained by applying offset correction and sensitivity correction to images for generating grid correction data, which are obtained by carrying out imaging for different positions of the second grating 3,

FIG. 11 is a flow chart for explaining operation of the breast imaging and display system employing one embodiment of the radiographic imaging apparatus of the invention,

FIG. 12 is a flow chart for explaining how correction data is updated in the breast imaging and display system employing one embodiment of the radiographic imaging apparatus of the invention,

FIG. 13 is a diagram illustrating an example of one radiation path which is refracted depending on a phase shift distribution Φ(x) of a subject with respect to an X-direction,

FIG. 14 is a diagram for explaining translational shift of the second grating,

FIG. 15 is a diagram for explaining how a phase contrast image is generated,

FIG. 16 is a diagram for explaining correction for a phase offset,

FIG. 17 is a diagram for explaining correction for a phase defective pixel,

FIG. 18 is a diagram illustrating a positional relationship among the self image of the first grating, the second grating and pixels of the radiographic image detector in a case where a plurality of fringe images are obtained in a single imaging operation,

FIG. 19 is a diagram for explaining how an inclination angle of the self image of the first grating relative to the second grating is set,

FIG. 20 is a diagram for explaining how the inclination angle of the self image of the first grating relative to the second grating is adjusted,

FIG. 21 is a diagram for explaining an operation to obtain the fringe images based on the image signals read out from the radiographic image detector,

FIG. 22 is a diagram for explaining the operation to obtain the fringe images based on the image signals read out from the radiographic image detector,

FIG. 23 is a diagram illustrating one example of a radiographic image detector of an optical reading system,

FIG. 24 is a diagram for explaining an operation to record a radiographic image on the radiographic image detector shown in FIG. 23,

FIG. 25 is a diagram for explaining an operation to read out a radiographic image from the radiographic image detector shown in FIG. 23,

FIG. 26 is a diagram for explaining how an absorption image and a small-angle scattering image are generated, and

FIG. 27 is a diagram for explaining a configuration where the first and second gratings are rotated by 90°.

### DESCRIPTION OF THE PREFERRED EMBODIMENTS

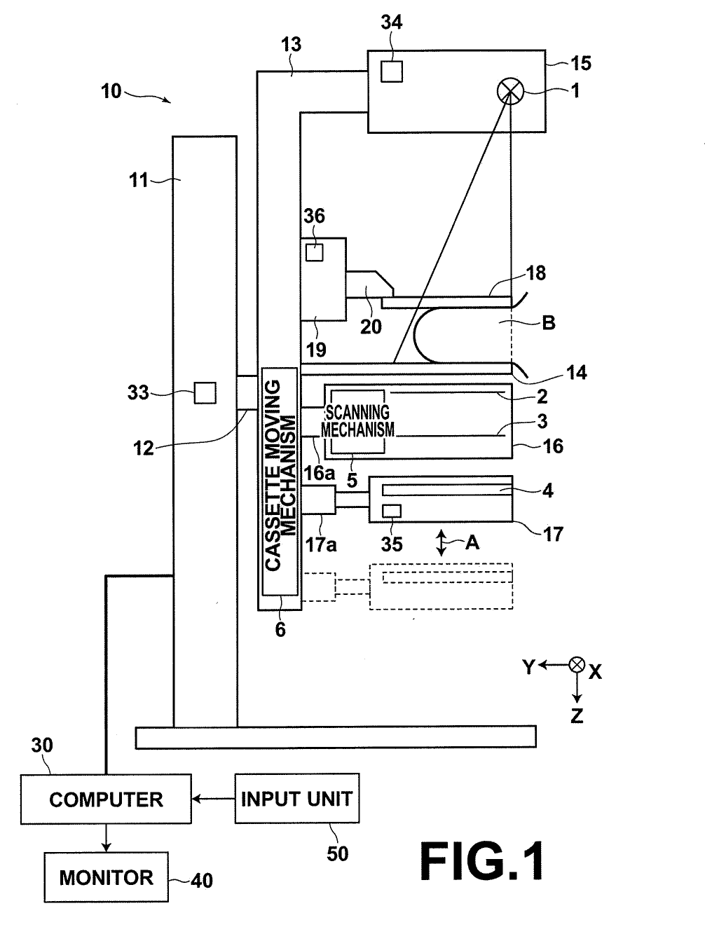

Hereinafter, a breast imaging and display system employing one embodiment of a radiographic imaging apparatus of the present invention will be described with reference to the drawings. FIG. 1 is a schematic configuration diagram of the entire breast imaging and display system employing one embodiment of the invention.

As shown in FIG. 1, this breast imaging and display system includes a breast imaging apparatus 10, a computer 30 connected to the breast imaging apparatus 10, and a monitor 40 and an input unit 50 connected to the computer 30.

Further, as shown in FIG. 1, the breast imaging apparatus 10 includes a base 11, a rotating shaft 12 that is movable in the vertical direction (the Z-direction) and rotatable relative to the base 11, and an arm 13 linked to the base 11 via the rotating shaft 12.

The arm 13 has a “C” shape. An imaging table 14, on which a breast B is placed, is disposed on one side of the arm 13, and a radiation source unit 15 is disposed on the other side of the arm 13 so as to face the imaging table 14. The movement of the arm 13 in the vertical direction is controlled by an arm controller 33, which is built in the base 11.

Further, a grid unit 16 and a cassette unit 17 are disposed in this order from the imaging table 14 on the side of the imaging table 14 opposite from the surface of the imaging table 14 where the breast is placed.

The grid unit 16 is connected to the arm 13 via a grid support 16a, on which the grid unit 16 is supported in a removable manner. The grid unit 16 contains therein a first grating 2, a second grating 3 and a scanning mechanism 5, which will be described in detail later. It should be noted that, although the grid unit 16 is adapted to be removable so that it can be attached to and removed from the grid support 16a in this embodiment, this is not intended to limit the invention. For example, the grid unit 16 may be adapted to be retractable from the optical path of the radiation in the state where the grid unit 16 is mounted on the arm 13 so that the grid unit 16 can be placed in and removed from the optical path of the radiation. That is, “removable” herein refers not only to a configuration where a member can be attached and removed, but also to a configuration where the member is retractable, as described above.

In this embodiment, various types of grid units 16, such as those having different sizes, are adapted to be removable.

The cassette unit 17 is connected to the arm 13 via a cassette support 17a, on which the cassette unit 17 is supported in a removable manner.

It should be noted that, although the cassette unit 17 is adapted to be removable so that it can be attached to and removed from the cassette support 17a in this embodiment, this is not intended to limit the invention. For example, similarly to the grid unit 16, the cassette unit 17 may be adapted to be retractable from the optical path of the radiation in the state where the cassette unit 17 is mounted on the arm 13 so that the cassette unit 17 can be placed in and removed from the optical path of the radiation.

In this embodiment, various types of cassette units 17, such as those having different sizes, are adapted to be removable.

The arm 13 contains therein a cassette moving mechanism 6, which moves the cassette support 17a in the vertical direction (the Z-direction). The cassette moving mechanism 6 moves the cassette unit 17 by a distance according to a magnification factor for magnification imaging, and is controlled by the arm controller 33. It should be noted that, assuming that a distance between the focal spot of the radiation source 1 and the breast B is “a” and a distance between the focal spot of the radiation source 1 and the detection plane of the radiographic image detector 4 is “b”, the magnification factor in this embodiment is expressed as M=b/a.

The cassette unit 17 contains therein a radiographic image detector 4, such as a flat panel detector, and a detector controller 35, which controls reading of electric charge signals from the radiographic image detector 4, etc. Although not shown in the drawing, the cassette unit 17 further contains therein a circuit board, which includes a charge amplifier for converting the electric charge signals read out from the radiographic image detector 4 into voltage signals, a correlated double sampling circuit for sampling the voltage signals outputted from the charge amplifier, an AD conversion unit for converting the voltage signals into digital signals, etc.

The radiographic image detector 4 is of a type that is repeatedly usable to record and read a radiographic image. The radiation detector 4 may be a so-called direct-type radiographic image detector, which directly receives the radiation and generates electric charges, or may be a so-called indirect-type radiographic image detector, which once converts the radiation into visible light, and then, converts the visible light into an electric charge signal. As the reading system to read out the radiographic image signal, a so-called TFT reading system that reads out the radiographic image signal with turning on and off TFT (thin film transistor) switches, or a so-called optical reading system that reads out the radiographic image signal by applying reading light may be used; however, this is not intended to limit the invention, and any other system may be used.

The radiation source unit 15 contains therein a radiation source 1 and a radiation source controller 34. The radiation source controller 34 controls timing of emission of radiation from the radiation source 1 and radiation generation conditions (such as tube current, exposure time, tube voltage, etc.) of the radiation source 1.

Further, a compression paddle 18 disposed above the imaging table 14 for holding and compressing the breast, a compression paddle support 20 for supporting the compression paddle 18, and a compression paddle moving mechanism 19 for moving the compression paddle support 20 in the vertical direction (the Z-direction) are disposed at the arm 13. The position and the compressing pressure of the compression paddle 18 are controlled by a compression paddle controller 36.

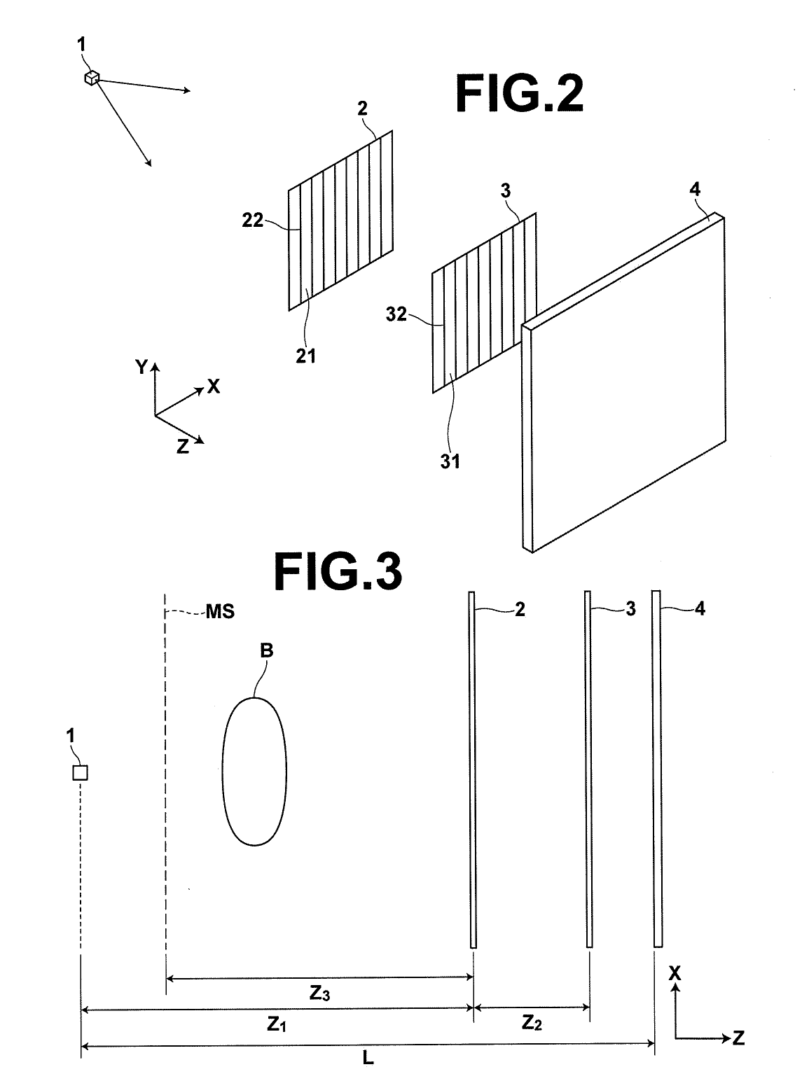

The breast imaging and display system of this embodiment takes a phase contrast image of the breast B with using the radiation source 1, the first grating 2, the second grating 3 and the radiographic image detector 4. Now, the structures of the radiation source 1, the first grating 2 and the second grating 3 required for achieving the phase contrast imaging are described in more detail. FIG. 2 shows the radiation source 1, the first and second gratings 2 and 3 and the radiographic image detector 4 extracted from FIG. 1, and FIG. 3 is a schematic diagram of the radiation source 1, the first and second gratings 2 and 3 and the radiographic image detector 4 shown in FIG. 2 viewed from above.

The radiation source 1 emits radiation toward the breast B. The spatial coherence of the radiation is such that the Talbot interference effect occurs when the radiation is applied to the first grating 2. For example, a microfocus X-ray tube or a plasma X-ray source, which provides a small radiation emission point, may be used. In a case where a radiation source with a relatively large radiation emission point (a so-called focal spot size) is used, as in a clinical practice, a multislit MS with a predetermined pitch may be disposed on the radiation emission side. The detailed configuration of this case is described, for example, in Franz Pfeiffer, Timm Weikamp, Oliver Bunk, and Christian David, “Phase retrieval and differential phase-contrast imaging with low-brilliance X-ray sources”, Nature Physics 2, 258-261 (01 Apr 2006) Letters. It is necessary to determine a pitch P₀ of the slit MS to satisfy Expression (1) below:

P₀=P₂×Z₃/Z₂ (1)
where P₂ is a pitch of the second grating 3, Z₃ is a distance from the position of the multislit MS to the first grating 2, as shown in FIG. 3, and Z₂ is a distance from the first grating 2 to the second grating 3.

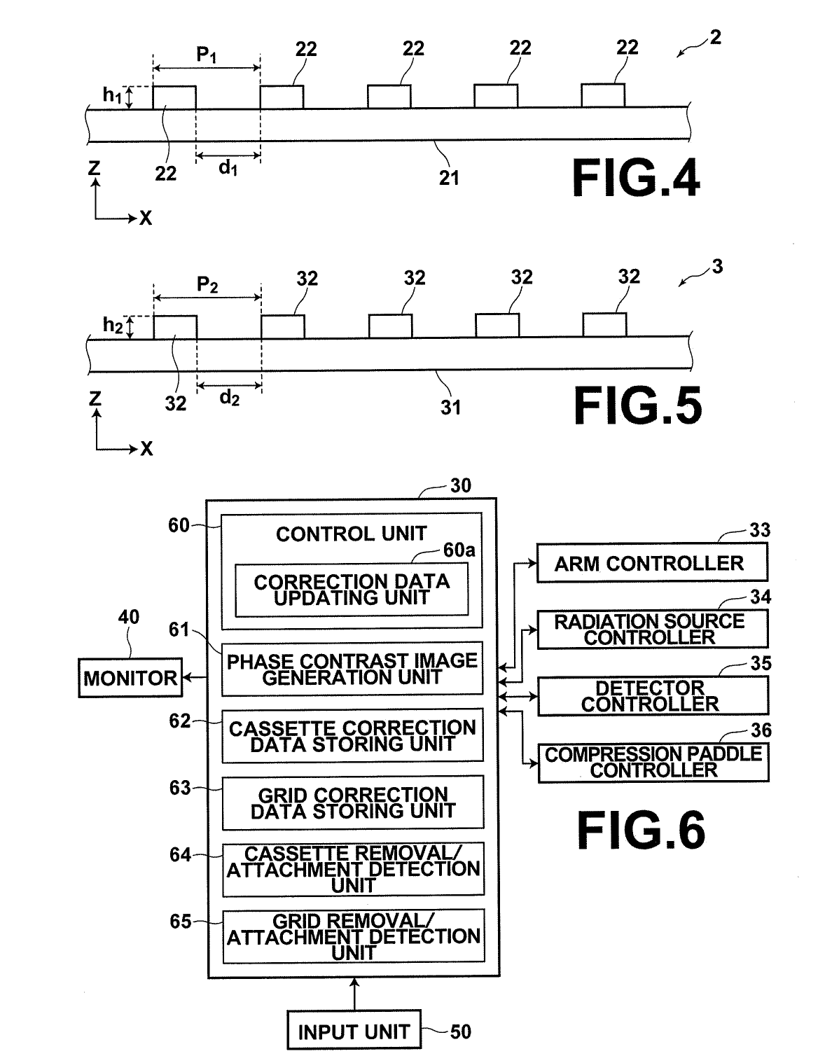

The first grating 2 allows the radiation emitted from the radiation source 1 to pass therethrough to form a first periodic pattern image, and includes a substrate 21, which mainly transmits the radiation, and a plurality of members 22 disposed on the substrate 21, as shown in FIG. 4. The members 22 are linear members extending along one direction in a plane orthogonal to the optical axis of the radiation (the Y-direction orthogonal to the X-direction and Z-direction, i.e., the direction orthogonal to the plane of FIG. 4). The members 22 are arranged at a predetermined interval d₁ with a constant period P₁ along the X-direction. The material forming the members 22 may be a metal, such as gold or platinum. It is desirable that the first grating 2 is a so-called phase modulation grating, which applies phase modulation of about 90° or about 180° to the radiation applied thereto. If the members 22 are made of gold, for example, the necessary thickness h₁ of the members 22 for an X-ray energy region for usual medical diagnosis is on the order of one micrometer to ten micrometers. Alternatively, an amplitude modulation grating may be used. In this case, the members 22 need to have a thickness for sufficiently absorbing the radiation. If the members 22 are made of gold, for example, the necessary thickness h₁ of the members 22 for an X-ray energy region for usual medical diagnosis is on the order of ten micrometers to several hundreds micrometers.

The second grating 3 applies intensity modulation to the first periodic pattern image formed by the first grating 2 to form a second periodic pattern image, and includes, similarly to the first grating 2, a substrate 31, which mainly transmits the radiation, and a plurality of members 32 disposed on the substrate 31, as shown in FIG. 5. The members 32 shield the radiation. The members 32 are linear members extending along one direction in a plane orthogonal to the optical axis of the radiation (the Y-direction orthogonal to the X-direction and Z-direction, i.e., the direction orthogonal to the plane of FIG. 5). The members 32 are arranged at a predetermined interval d₂ with a constant period P₂ along the X-direction. The material forming the members 32 may be a metal, such as gold or platinum. It is desirable that the second grating 3 is an amplitude modulation grating. In this case, the members 32 need to have a thickness for sufficiently absorbing the radiation. If the members 32 are made of gold, for example, the necessary thickness h₂ of the members 32 for an X-ray energy region for usual medical diagnosis is on the order of ten micrometers to several hundreds micrometers.

In a case where the radiation emitted from the radiation source 1 is not a parallel beam but a cone beam, the self image G1 of the first grating 2 formed by the radiation passed through the first grating 2 is magnified in proportion to the distance from the radiation source 1. In this embodiment, the grating pitch P₂ and the interval d₂ of the second grating 3 are determined such that the slits of the second grating 3 are almost aligned with the periodic pattern of light areas of self image G1 of the first grating 2 at the position of the second grating 3. That is, assuming that the distance from the focal spot of the radiation source 1 to the first grating 2 is Z₁ and the distance from the first grating 2 to the second grating 3 is Z₂, in the case where the first grating 2 is a phase modulation grating that applies phase modulation of 90° or an amplitude modulation grating, the pitch P₂ of the second grating is determined to satisfy the relationship defined as the Expression (2) below:

$${P}_{2} = {P}_{1}^{′} = \frac{{Z}_{1} + {Z}_{2}}{{Z}_{1}} {P}_{1} \qquad ( 2 )$$

where P₁′ is a pitch of the self image G1 formed by the first grating 2 at the position of the second grating 3. Alternatively, in the case where the first grating 2 is a phase modulation grating that applies phase modulation of 180°, the pitch P₂ of the second grating is determined to satisfy the relationship defined as the Expression (3) below:

$${P}_{2} = {P}_{1}^{′} = \frac{{Z}_{1} + {Z}_{2}}{{Z}_{1}} \cdot \frac{{P}_{1}}{2} \qquad ( 3 )$$

It should be noted that, in a case where the radiation emitted from the radiation source 1 is a parallel beam, if the first grating 2 is a 90° phase modulation grating or an amplitude modulation grating, the pitch P₂ of the second grating is determined to satisfy:

P₂=P₁,
or if the first grating 2 is a 180° phase modulation grating, the pitch P₂ of the second grating is determined to satisfy:

P₂=P₁/2.

In order to make the breast imaging apparatus 10 of this embodiment function as a Talbot interferometer, some more conditions must almost be satisfied. Now, the conditions are described.

First, it is necessary that grid planes of the first grating 2 and the second grating 3 are parallel to the X-Y plane shown in FIG. 2.

Further, if the first grating 2 is a phase modulation grating that applies phase modulation of 90°, then, the distance Z₂ between the first grating 2 and the second grating 3 must almost satisfy the condition below:

$${Z}_{2} = ( m + \frac{1}{2} ) \frac{{P}_{1} {P}_{2}}{λ} \qquad ( 4 )$$

where λ is the wavelength of the radiation (which is typically the effective wavelength), m is 0 or a positive integer, P₁ is the above-described grating pitch of the first grating 2, and P₂ is the above-described grating pitch of the second grating 3.

Alternatively, if the first grating 2 is a phase modulation grating that applies phase modulation of 180°, then, the distance Z₂ between the first grating 2 and the second grating 3 must almost satisfy the condition below:

$${Z}_{2} = ( m + \frac{1}{2} ) \frac{{P}_{1} {P}_{2}}{2 λ} \qquad ( 5 )$$

where λ is the wavelength of the radiation (which is typically the effective wavelength), m is 0 or a positive integer, P₁ is the above-described grating pitch of the first grating 2, and P₂ is the above-described grating pitch of the second grating 3.

Still alternatively, if the first grating 2 is an amplitude modulation grating, then, the distance Z₂ between the first grating 2 and the second grating 3 must almost satisfy the condition below:

$${Z}_{2} = {m}^{′} \frac{{P}_{1} {P}_{2}}{λ} \qquad ( 6 )$$

where λ is the wavelength of the radiation (which is typically the effective wavelength), m′ is a positive integer, P₁ is the above-described grating pitch of the first grating 2, and P₂ is the above-described grating pitch of the second grating 3.

It should be noted that the above Expressions (4), (5) and (6) are used in the case where the radiation emitted from the radiation source 1 is a cone beam. In the case where the radiation emitted from the radiation source 1 is a parallel beam, Expression (7) below is applied in place of Expression (4), Expression (8) below is applied in place of Expression (5), and Expression (9) below is applied in place of Expression (6):

$$\begin{matrix}{Z}_{2} = ( m + \frac{1}{2} ) \frac{{P}_{1}^{2}}{λ} & ( 7 ) \\ {Z}_{2} = ( m + \frac{1}{2} ) \frac{{P}_{1}^{2}}{4 λ} & ( 8 ) \\ {Z}_{2} = m \frac{{P}_{1}^{2}}{λ} & ( 9 )\end{matrix}$$

Further, as shown in FIGS. 4 and 5, the members 22 of the first grating 2 are formed to have the thickness h₁ and the members 32 of the second grating 3 are formed to have the thickness h₂. If the thickness h₁ and the thickness h₂ are excessively thick, it is difficult for parts of the radiation that obliquely enter the first grating 2 and the second grating 3 to pass through the slits of the gratings, and this results in so-called vignetting, which narrows an effective field of view in a direction (the X-direction) orthogonal to the direction along which the members 22 and 32 extend. In view of ensuring the field of view, it is preferred to define the upper limits of the thicknesses h₁ and h₂. In order to ensure a length V of the effective field of view in the X-direction in the detection plane of the radiographic image detector 4, it is preferred to set the thicknesses h₁ and h₂ to satisfy Expressions (10) and (11) below:

$$\begin{matrix}{h}_{1} \leq \frac{L}{V / 2} {d}_{1} & ( 10 ) \\ {h}_{2} \leq \frac{L}{V / 2} {d}_{2} & ( 11 )\end{matrix}$$

where L is a distance from the focal spot of the radiation source 1 to the detection plane of the radiographic image detector 4 (see FIG. 3).

The scanning mechanism 5 disposed in the grid unit 16 shifts the position of the second grating 3 as described above to translate it in the direction (the X-direction) orthogonal to the direction along which the members 32 extend, thereby changing the relative positions of the first grating 2 and the second grating 3. The scanning mechanism 5 may be formed, for example, by an actuator, such as a piezoelectric device. Then, the second periodic pattern image formed by the second grating 3 at each position of the second grating 3 shifted by the scanning mechanism 5 is detected by the radiographic image detector 4.

FIG. 6 is a block diagram illustrating the configuration of the computer 30 shown in FIG. 1. The computer 30 includes a central processing unit (CPU), a storage device, such as a semiconductor memory, a hard disk or a SSD, etc., and these hardware devices form a control unit 60, a phase contrast image generation unit 61, a cassette correction data storing unit 62, a grid correction data storing unit 63, a cassette removal/attachment detection unit 64 and a grid removal/attachment detection unit 65, as shown in FIG. 6.

The control unit 60 outputs predetermined control signals to the various controllers 33 to 36 to control the entire system. The control unit 60 controls the cassette moving mechanism 6, shown in FIG. 1, based on a magnification factor for magnification imaging inputted by the operator via the input unit 50.

The control unit 60 includes a correction data updating unit 60a. The correction data updating unit 60a controls the radiation source 1, the radiographic image detector 4, etc., to obtain and update cassette correction data and grid correction data, which will be described later, in response to an instruction to start calibration inputted by the operator via the input unit 50.

The correction data updating unit 60a updates the cassette correction data and the grid correction data independently from each other depending on the state of removal and attachment of the cassette unit 17, the state of removal and attachment of the grid unit 16, whether or not the magnification factor is changed, etc. How the update is achieved will be described in detail later.

The phase contrast image generation unit 61 generates a radiographic phase contrast image based on image signals of a plurality of different fringe images, which are detected by the radiographic image detector 4 at different positions of the second grating 3. The method for generating the radiographic phase contrast image will be described in detail later.

The cassette correction data storing unit 62 stores the cassette correction data for correction for the characteristics of the radiographic image detector 4. Specifically, in this embodiment, the cassette correction data includes offset correction data, sensitivity correction data and defective pixel correction data. It should be noted that the cassette correction data with respect to the radiographic image detector 4 also includes linearity correction data, residual image correction data, etc.; however, these correction data items are usually obtained at the time of shipping, and the method for obtaining the correction data items is the same as that for usual radiographic image detectors, and thus are not described in detail this embodiment.

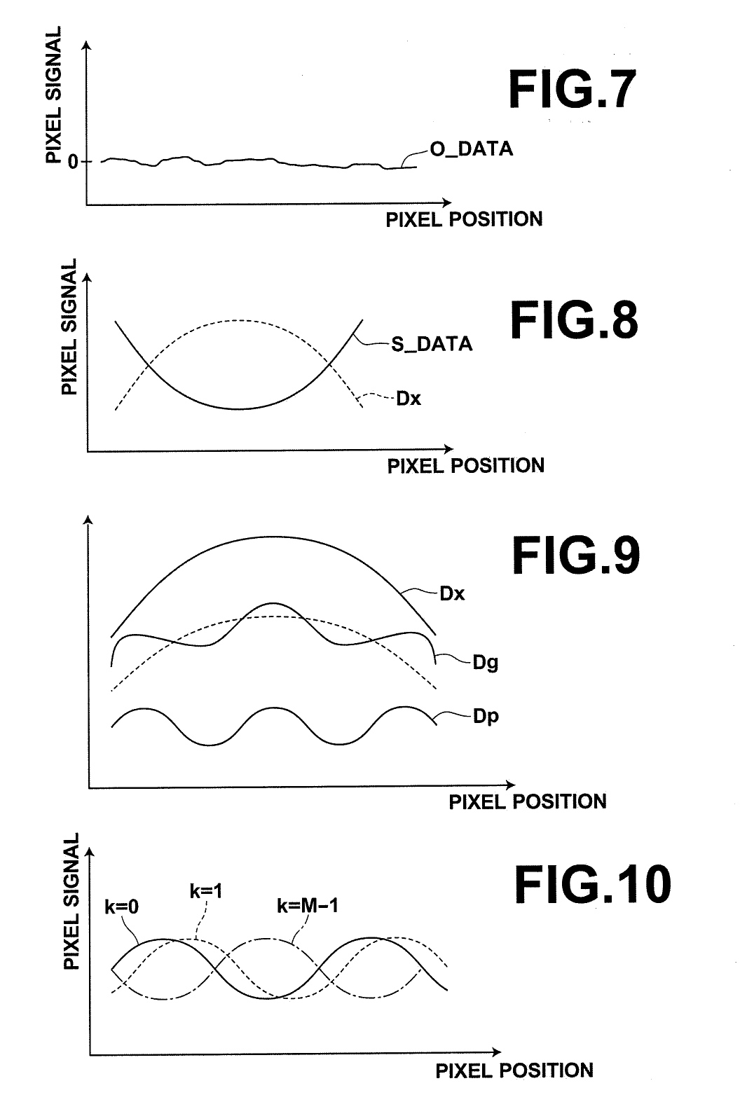

The offset correction data is generated based on an image for offset correction, which is outputted from the radiographic image detector 4 in a state where no radiation is applied to the radiographic image detector 4. FIG. 7 schematically shows one example of the offset correction data “O_data”. It is desirable that the offset correction data “O_data” is obtained by averaging a plurality of images for offset correction for each pixel in order to reduce random noise.

The sensitivity correction data is generated based on an image Dx for generating sensitivity correction data, which is outputted from the radiographic image detector 4 when a uniform radiation not passing through the subject and the first and second gratings 2 and 3 is applied to the radiographic image detector 4. Specifically, the sensitivity correction data “S_data” is generated based on an image which is obtained by applying offset correction to the image Dx for generating sensitivity correction data with using the above-described offset correction data “O_data”, and is calculated according to the Expression below:

S_data=C/(Dx−O_data),
where C is a normalization coefficient.

It is desirable that the sensitivity correction data “S_data” is generated based on an image obtained by averaging a plurality of images Dx for generating sensitivity correction data subjected to the offset correction, as shown by the above Expression, in order to reduce random noise. FIG. 8 schematically shows one example of the sensitivity correction data “S_data”, which is generated based on the image Dx for generating sensitivity correction data.

It should be noted that the sensitivity correction data “S_data” is generated based on the image for generating sensitivity correction data, which is obtained when the radiographic image detector 4 is irradiated without any subjects including the first and second gratings 2 and 3. As described above, retraction of the grid unit 16 may automatically be conducted when the image for generating sensitivity correction data is taken, or a message to prompt the operator to remove the grid unit 16 may be displayed on the monitor 40 when the image for generating sensitivity correction data is taken so that the grid unit 16 is removed by the operator.

The defective pixel correction data is generated with using an image for generating defective pixel correction data, which is outputted from the radiographic image detector 4 in a state where radiation is applied to the radiographic image detector 4 or no radiation is applied to the radiographic image detector 4. Specifically, each pixel of the image for generating defective pixel correction data is subjected to thresholding using a predetermined threshold value to extract a defective pixel, and address information of the defective pixel is obtained and stored as the defective pixel correction data. It should be noted that the method to extract the defective pixel is not limited to the above method, and any of various known methods may be used.

In the case where the defective pixel correction data is obtained when the radiation is applied, it is preferred to retract the grid unit 16 in the same manner as in the sensitivity correction data acquisition.

The grid correction data storing unit 63 stores grid correction data for correction for the characteristics of the first and second gratings. In this embodiment, the grid correction data includes correction data with respect to in-plane variation of the grating pitches of the first and second gratings 2 and 3 and relative positional displacement between the first and second gratings 2 and 3 (which will hereinafter be referred to as “phase offset correction data”) and correction data with respect to defect of the gratings (which will hereinafter be referred to as “phase defect correction data”) when the phase contrast image is generated. The grid correction data is obtained by a process similar to a process to generate the phase contrast image, which will be described later, when radiation passing through the first grating 2 and the second grating 3 is detected by the radiographic image detector 4 in a state where the subject B is not placed.

Specifically, similarly to the case where the phase contrast image is taken, which will be described later, the grid correction data is generated from images formed by the first grating 2 and the second grating 3 for different positions of the second grating 3, which is shifted relative to the first grating 2 in the X-direction (the direction orthogonal to the direction along which the members 32 of the second grating 3 extends) by a fraction of the arrangement pitch P₂ divided by an integer, and detected by the radiographic image detector 4.

In this embodiment, a plurality of images Dg for generating grid correction data, which are obtained as described above for generating the grid correction data, are subjected to the offset correction and the sensitivity correction with respect to the radiographic image detector 4 and the resulting images are obtained as image data Dp(k=0 to M−1) for generating grid correction data, as expressed by the Expression below:

Dp(k=0 to M−1)=(Dg(k=0 to M−1)−O_data)×S_data.

FIG. 9 shows a relationship among the image Dx for generating sensitivity correction data, the image Dg for generating grid correction data before sensitivity correction and the image Dp for generating grid correction data after sensitivity correction. FIG. 10 schematically shows one example of the images Dp (k=0 to M−1) for generating grid correction data which are obtained by applying the offset correction and the sensitivity correction to the images Dg (k=0 to M−1) for generating grid correction data, which are taken for different positions k (k=0 to M−1) of the second grating 3. It should be focused that the thus obtained images for generating grid correction data have been corrected for the characteristics of the detector, where the characteristics of the grid are separated and extracted. Then, the grid correction data, such as the phase offset correction data, the phase defect correction data, etc., is generated from the images for generating grid correction data by the operation which will be described in detail later, and is stored in the grid correction data storing unit 63.

The cassette removal/attachment detection unit 64 detects removal and attachment of the cassette unit 17 from and onto the cassette support 17a. The cassette removal/attachment detection unit 64 may detect the removal and attachment of the cassette unit 17 by detecting, for example, whether an electrical contact is established or not, or by detecting an output from an optical sensor, or the like.

The grid removal/attachment detection unit 65 detects removal and attachment of the grid unit 16 from and onto the grid support 16a. Similarly to the cassette removal/attachment detection unit 63, the grid removal/attachment detection unit 65 may detect the removal and attachment of the grid unit 16 by detecting, for example, whether an electrical contact is established or not, or by detecting an output from an optical sensor, or the like.

The monitor 40 displays the phase contrast image generated by the phase contrast image generation unit 61 in the computer 30.

The input unit 50 includes, for example, a keyboard and a pointing device, such as a mouse. The input unit 50 receives an input, such as imaging conditions and an instruction to start imaging, by the operator. In this embodiment, the input unit 50 receives, in particular, an input of the magnification factor for magnification imaging.

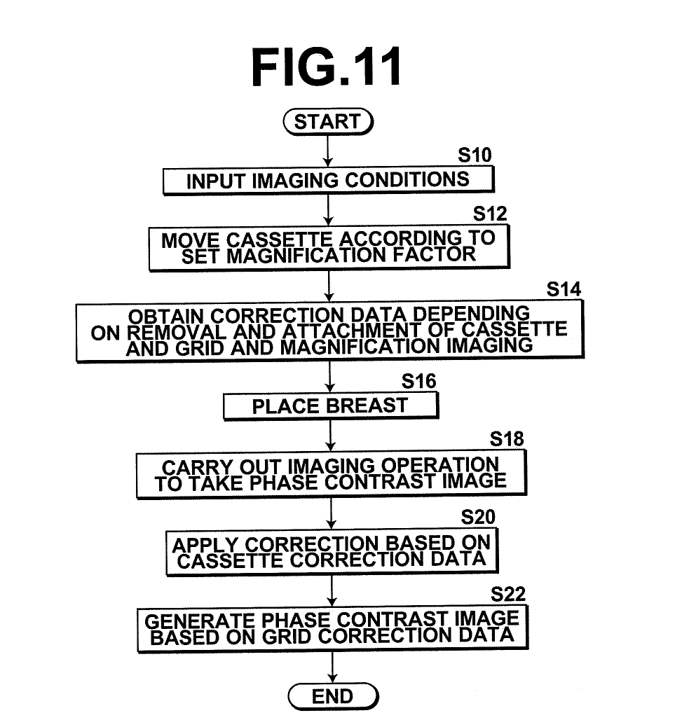

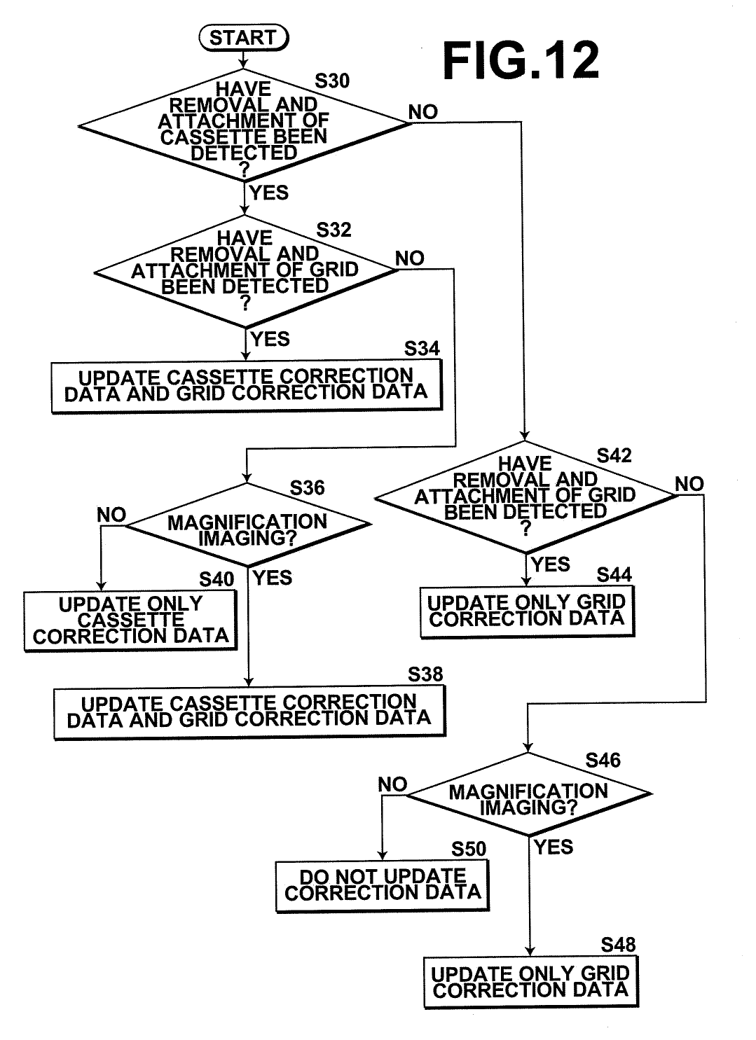

Next, operation of the breast imaging and display system of this embodiment is described with reference to the flow charts shown in FIGS. 11 and 12.

First, various imaging conditions are inputted by the operator via the input unit 50 (S10). In the case where magnification imaging is carried out, a magnification factor is inputted, and the magnification factor received via the input unit 50 is outputted to the control unit 60.

Then, in the case where the magnification factor for magnification imaging is inputted, the control unit 60 outputs a control signal to the arm controller 33 so that the magnification imaging is carried out according to the inputted magnification factor, and the arm controller 33 controls driving by the cassette moving mechanism 6 according to the control signal so that the cassette moving mechanism 6 moves the cassette unit 17 in the vertical direction (S12). That is, the cassette moving mechanism 6 moves the cassette unit 17 along the Z-direction such that the distance between the radiation source 1 and the detection plane of the radiographic image detector 4 becomes a distance according to the magnification factor set and inputted by the operator.

Subsequently, an instruction to start calibration is inputted by the operator via the input unit 50. Then, the instruction to start calibration received via the input unit 50 is inputted to the correction data updating unit 60a of the control unit 60. Then, the correction data updating unit 60a selects an item of the correction data to be updated depending on the detection state of removal and attachment of each of the grid unit 16 and the cassette unit 17 and whether or not the magnification factor is changed, and starts to obtain the selected item of the correction data (S14).

Now, operation of the correction data updating unit 60a is specifically described with reference to the flow chart shown in FIG. 12.

First, the correction data updating unit 60a obtains, from the cassette removal/attachment detection unit 64 and the grid removal/attachment detection unit 65, information about whether or not each of the cassette unit 17 and the grid unit 16 have been removed and attached between the previous imaging operation to take a phase contrast image and the current imaging operation to take a phase contrast image.

Then, if both the cassette unit 17 and the grid unit 16 have been removed and attached (S30: YES, and S32: YES), the correction data updating unit 60a controls the radiation source 1, the radiographic image detector 4, etc., to obtain both the cassette correction data and the grid correction data. Then, the obtained cassette correction data is stored and updated in the cassette correction data storing unit 62, and the obtained grid correction data is stored and updated in the grid correction data storing unit 63 (S34).

If only the cassette unit 17 has been removed and attached and the grid unit 16 has not been removed and attached (S30: YES, and S32: NO), the correction data updating unit 60a checks whether or not an instruction to carry out magnification imaging has been made by the operator. If the instruction to carry out magnification imaging has been made (S36: YES), the correction data updating unit 60a controls the radiation source 1, radiographic image detector 4, etc., to obtain both the cassette correction data and grid correction data. Then, the obtained cassette correction data is stored and updated in the cassette correction data storing unit 62, and the obtained grid correction data is stored and updated in the grid correction data storing unit 63 (S38). In contrast, if the instruction to carry out magnification imaging has not been made by the operator (S36: NO), the correction data updating unit 60a controls the radiation source 1, radiographic image detector 4, etc., to obtain only the cassette correction data among the cassette correction data and the grid correction data. Then, the obtained cassette correction data is stored and updated in the cassette correction data storing unit 62, and the grid correction data is not updated (S40).

If the cassette unit 17 has not been removed and attached and only the grid unit 16 has been removed and attached (S30: NO, S42: YES), the correction data updating unit 60a controls the radiation source 1, radiographic image detector 4, etc., to obtain only the grid correction data among the cassette correction data and the grid correction data. Then, the obtained grid correction data is stored and updated in the grid correction data storing unit 63, and the cassette correction data is not updated (S44).

On the other hand, if both the cassette unit 17 and the grid unit 16 have not been removed and attached (S30: NO, S42: NO), the correction data updating unit 60a checks whether or not an instruction to change the magnification factor has been made by the operator. If the instruction to change the magnification factor has been made (S46: YES), the correction data updating unit 60a controls the radiation source 1, radiographic image detector 4, etc., to obtain only the grid correction data among the cassette correction data and the grid correction data. Then, the obtained grid correction data is stored and updated in the grid correction data storing unit 63, and the cassette correction data is not updated (S48). In contrast, if the instruction to change the magnification factor has not been made by the operator (S46: NO), none of the cassette correction data and the grid correction data is updated (S50).

As described above, the correction data updating unit 60a selects an item of the correction data to be updated depending on the detection state of removal and attachment of each of the grid unit 16 and the cassette unit 17 and whether or not the magnification factor is changed, and updates the selected item of the correction data.

After the correction data has been updated as described above, the imaging operation to take the phase contrast image is started.

Specifically, returning to the flow chart shown in FIG. 11, first, the breast B is placed on the imaging table 14, and the compression paddle 18 compresses the breast B with a predetermined pressure (S16).

Then, an instruction to start imaging to take the phase contrast image is inputted by the operator via the input unit 50, and radiation is emitted from the radiation source 1 in response to the input of the instruction to start imaging (S18).

The radiation is transmitted through the breast B and is applied onto the first grating 2. The radiation applied onto the first grating 2 is diffracted by the first grating 2 to form a Talbot interference image at a predetermined distance from the first grating 2 in the direction of the optical axis of the radiation.

This phenomenon is called the Talbot effect where, when the light wave passes through the first grating 2, a self image G1 of the first grating 2 is formed at a predetermined distance from the first grating 2. For example, in the case where the first grating 2 is a phase modulation grating that applies phase modulation of 90°, the self image G1 of the first grating 2 is formed at the distance found by Expression (4) or (7) above (Expression (5) or (8) above in the case where the first grating 2 is a phase modulation grating that applies phase modulation of 180°, and Expression (6) or (9) above in the case where the first grating 2 is an intensity modulation grating). On the other hand, the wave front of the radiation entering the first grating 2 is distorted by the breast B, which is the subject, and the self image G1 of the first grating 2 is deformed accordingly.

Subsequently, the radiation passes through the second grating 3. As a result, the deformed self image G1 of the first grating 2 is superposed on the second grating 3 to be subjected to intensity modulation, and then is detected by the radiographic image detector 4 as an image signal which reflects the above-described distortion of the wave front. Then, the image signal detected by the radiographic image detector 4 is inputted to the phase contrast image generation unit 61 of the computer 30.

Then, the phase contrast image generation unit 61 applies the offset correction, the sensitivity correction and the defective pixel correction to the inputted image signals with using the cassette correction data stored in the cassette correction data storing unit 62, and generates the phase contrast image based on the image signals subjected to the cassette correction (S20).

Next, how the phase contrast image is generated at the phase contrast image generation unit 61 is described. First, the principle of a method for generating the phase contrast image in this embodiment is described.

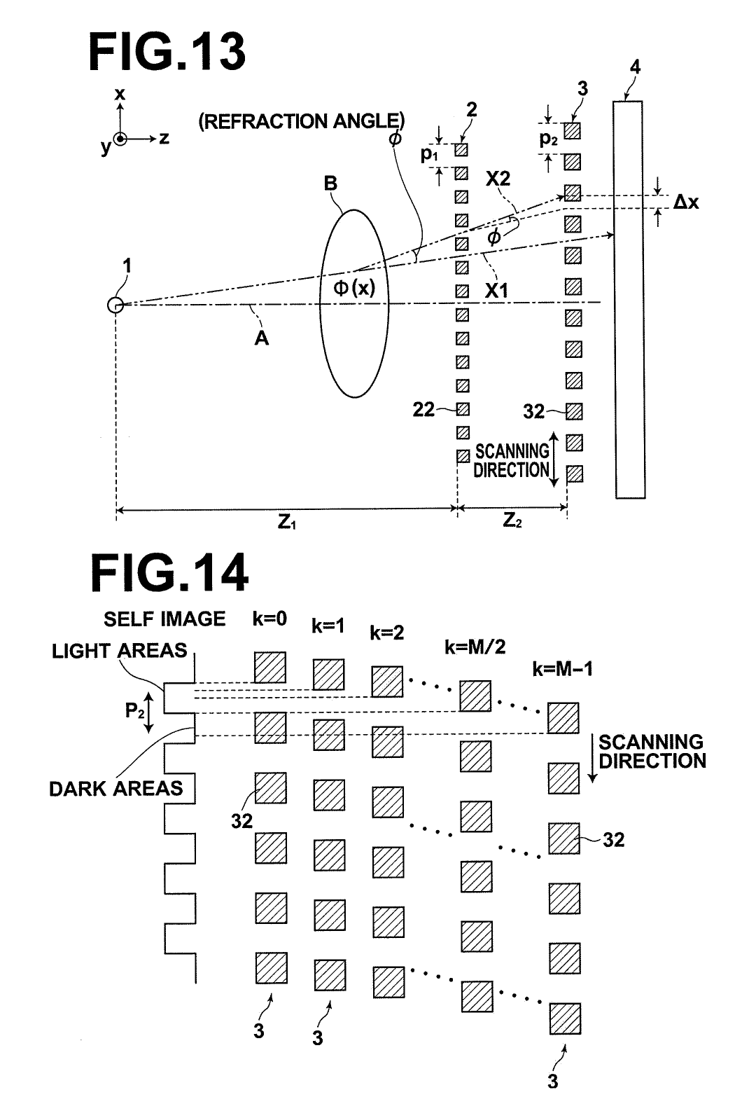

FIG. 13 shows an example of one radiation path which is refracted depending on a phase shift distribution Φ(x) of the subject B with respect to the X-direction. The symbol X1 denotes a straight radiation path in a case where the subject B is not present. The radiation traveling along the path X1 passes through the first grating 2 and the second grating 3 and enters the radiographic image detector 4. The symbol X2 denotes a radiation path which is deflected due to refraction by the subject B in a case where the subject B is present. The radiation traveling along the path X2 passes through the first grating 2, and then is shielded by the second grating 3.

Assuming that a refractive index distribution of the subject B is n (x, z), and a direction in which the radiation travels is z, the phase shift distribution Φ(x) of the subject B is expressed by Expression (12) below (where the y-coordinate is omitted for simplifying explanation):

$$Φ ( x ) = \frac{2 π}{λ} \int [ 1 - n ( n , z ) ] d z \qquad ( 12 )$$

A self image G1 formed by the first grating 2 at the position of the second grating 3 is displaced in the x-direction by an amount depending on the refraction angle φ of the refraction of radiation by the subject B. The amount of displacement Δx is approximately expressed by Expression (13) below based on the fact that the refraction angle φ of the radiation is very small:

Δx≈Z₂φ (13)

The refraction angle φ is expressed by Expression (14) below with using the wavelength λ of the radiation and the phase shift distribution Φ(x) of the subject B:

$$ϕ = \frac{λ}{2 π} \frac{\partial Φ ( x )}{\partial x} \qquad ( 14 )$$

In this manner, the amount of displacement Δx of the self image G1 due to the refraction of radiation by the subject B is linked to the phase shift distribution Φ(x) of the subject B. Then, the amount of displacement Δx is linked to an amount of phase shifting Ψ of an intensity-modulated signal of each pixel detected by the radiographic image detector 4 (an amount of phase shifting of the intensity-modulated signal of each pixel between the cases where the subject B is present and where the subject B is not present), as expressed by Expression (15) below:

$$ψ = \frac{2 π}{{P}_{2}} Δ x = \frac{2 π}{{P}_{2}} {Z}_{2 ϕ} \qquad ( 15 )$$

Therefore, by finding the amount of phase shifting Ψ of the intensity-modulated signal of each pixel, the refraction angle φ is found from Expression above (15), and a differential of the phase shift distribution Φ(x) is found with using Expression (14) above. By integrating the differential with respect to x, the phase shift distribution Φ(x) of the subject B, i.e., the phase contrast image of the subject B can be generated. In this embodiment, the amount of phase shifting Ψ is calculated with using the fringe scanning method described below.

In the fringe scanning method, the imaging operation as described above is carried out with shifting (translating) one of the first grating 2 and the second grating 3 in the X-direction relative to the other of the first grating 2 and the second grating 3. It should be noted that each image taken for each position is detected as a fringe image by the radiographic image detector 4 due to moire, which is formed by superposing the self image G1 of the first grating 2 on the second grating 3, and thus this image will hereinafter be referred to as “fringe image”. In this embodiment, the second grating 3 is shifted by the scanning mechanism 5. As the second grating 3 is shifted, the fringe image detected by the radiographic image detector 4 moves. When a translation distance (an amount of shift in the X-direction) reaches one period of the arrangement period of the second grating 3 (the arrangement pitch P₂), i.e., when the phase variation between the self image G1 of the first grating 2 and the second grating 3 reaches 2π, the fringe image returns to the initial position. Such variation of the fringe image is detected by the radiographic image detector 4 with shifting the second grating 3 by a fraction of the arrangement pitch P₂ divided by an integer to detect a plurality of fringe images, and the intensity-modulated signal of each pixel is obtained from the detected fringe images to obtain the amount of phase shifting Ψ of the intensity-modulated signal of each pixel.

FIG. 14 schematically shows how the second grating 3 is shifted by a pitch (P₂/M), which is a fraction of the arrangement pitch P₂ divided by M (which is an integer of 2 or more). The scanning mechanism 5 shifts the second grating 3 sequentially to M positions k (k=0, 1, 2, . . . , and M−1). It should be noted that, in FIG. 10, the initial position of the second grating 3 is a position of k=0 where, in the case where the subject B is not present, dark areas of the self image G1 of the first grating 2 at the position of the second grating 3 are almost aligned with the members 32 of the second grating 3. However, the initial position of the second grating 3 may be any of the M positions k (k=0, 1, 2, . . . , and M−1).

First, at the position of k=0, mainly part of the radiation that has not been refracted by the subject B passes through the second grating 3. As the second grating 3 is shifted sequentially to the positions of k=1, 2, . . . , and the like, a component of the radiation passing through the second grating 3 that has not been refracted by the subject B decreases, and a component of the radiation passing through the second grating 3 that has been refracted by the subject B increases. In particular, at the position of k=M/2, mainly, only the component of the radiation refracted by the subject B passes through the second grating 3. In contrast, at the positions beyond the position of k=M/2, the component of the radiation passing through the second grating 3 that has been refracted by the subject B decreases, and the component of the radiation passing through the second grating 3 that has not been refracted by the subject B increases.

By carrying out imaging by the radiographic image detector 4 at each of the positions of k=0, 1, 2, . . . , and M−1, M fringe image signals are obtained, and the image signals are stored in the phase contrast image generation unit 61. As described above, the phase contrast image generation unit 61 applies the offset correction, the sensitivity correction and the defective pixel correction to the inputted M fringe image signals with using the cassette correction data stored in the cassette correction data storing unit 62, and generates the phase contrast image based on the fringe images signals subjected to the cassette correction.

Now, how the amount of phase shifting Ψ of the intensity-modulated signal of each pixel is calculated from pixel signals for each pixel of the M fringe image signals subjected to the cassette correction is described.

First, each pixel signal Ik(x) for each pixel at each position k of the second grating 3 is expressed by Expression (16) below:

$${I}_{k} ( x ) = {A}_{0} + {\sum }_{n > 0} {A}_{n} exp [ 2 π i \frac{n}{{P}_{2}} \{ {Z}_{2} ϕ ( x ) + \frac{k {P}_{2}}{M} \} ] \qquad ( 16 )$$

where x is a coordinate of the pixel with respect to the x-direction, A₀ is an intensity of the incident radiation, and Aₙ is a value corresponding to the contrast of the intensity-modulated signal (where n is a positive integer). Further, ψ(x) represents the refraction angle φ as a function of the coordinate x of each pixel of the radiographic image detector 4.

Then, using the relational expression of Expression (17) below, the refraction angle φ(x) is expressed as Expression (18) below:

$$\begin{matrix}{\sum }_{k = 0}^{M - 1} exp ( - 2 π i \frac{k}{M} ) = 0 & ( 17 ) \\ ϕ ( x ) = \frac{{p}_{2}}{2 π {Z}_{2}} arg [ {\sum }_{k = 0}^{M - 1} {I}_{k} ( x ) exp ( - 2 πi \frac{k}{M} ) ] & ( 18 )\end{matrix}$$

where “arg[ ]” means extraction of an argument, and corresponds to the amount of phase shifting Ψ of the intensity-modulated signal at each pixel of the radiographic image detector 4. Therefore, the refraction angle φ(x) is found by calculating, based on Expression (18), the amount of phase shifting Ψ of the intensity-modulated signal of each pixel from the M corrected fringe image signals obtained for each pixel of the radiographic image detector 4.

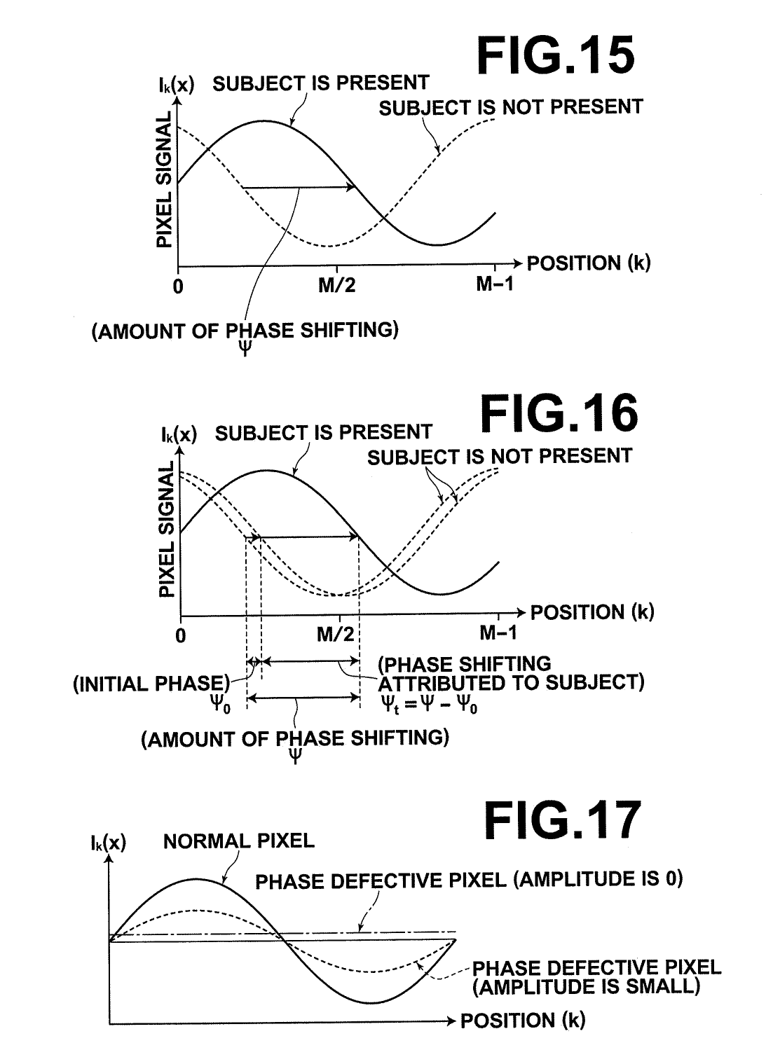

Specifically, as shown in FIG. 15, the M fringe image signals obtained for each pixel of the radiographic image detector 4 periodically vary with the period of the grating pitch P₂ of the second grating 3 relative to the position k of the second grating 3. In FIG. 15, the dashed line represents the variation of the fringe image signal in the case where the subject B is not present, and the solid line represents the variation of the fringe image signal in the case where the subject B is present. The phase difference between these waveforms corresponds to the amount of phase shifting Ψ of the intensity-modulated signal of each pixel.

On the other hand, the phase of the intensity-modulated signal in the case where the subject B is not present may vary pixel by pixel depending on the characteristics of the grid unit 16, such as the in-plane variation of the grating pitches of the first and second gratings 2 and 3 and the relative positional displacement between the first and second gratings 2 and 3, or relative positional displacement between the grid unit 16 and the radiographic image detector 4. Assuming that this is an initial phase Ψ₀ the above-mentioned amount of phase shifting Ψ is such that the initial phase Ψ₀ is superposed as an offset on an amount of phase shifting Ψₜ attributed to the subject B, as shown in FIG. 16. The initial phase Ψ₀ is the above-mentioned phase offset, and the pixel-by-pixel variation of the initial phase Ψ₀ introduces an artifact into the phase contrast image.

In order to correct for this phase offset and find the phase shifting Ψₜ attributed to the subject B, the amount of phase shifting Ψ of the intensity-modulated signal in the case where the subject B is not present is used as the initial phase Ψ₀ and is subtracted from the phase shifting Ψ in the case where the subject B is present. That is, the phase offset correction data can be used as the initial phase Ψ₀. In this embodiment, the grid correction data storing unit 63 stores, as the phase offset data, the initial phase Ψ₀ of the intensity-modulated signal at each pixel, which is obtained by calculating the phase shifting Ψ of the intensity-modulated signal of each pixel from the pixel signals of the above-described images Dp(k=0 to M−1) for generating grid correction data taken in the state where the subject B is not present, based on Expression (18) above.

Then, the phase contrast image generation unit 61 generates an intensity-modulated signal from each pixel signal of the M fringe image signals taken as described above and subjected to the cassette correction, and then, calculates the amount of phase shifting Ψ, calculates the amount of phase shifting Ψₜ attributed to the subject B based on a difference from the phase offset correction data (the initial phase Ψ₀) stored in the grid correction data storing unit 63, and calculates the refraction angle ψ(x) based on the amount of phase shifting Ψₜ.

In a case where at least one of the first and second gratings 2 and 3 has a void or dust adhering thereto, it is impossible to obtain the fringe image, which is formed by superposing the grating pattern image of the first grating 2 on the grating pattern of the second grating 3, at a pixel of the radiographic image detector 4 corresponding to the position of the void or dust, and no intensity-modulated signal can be obtained for the pixel. This pixel is referred to as “phase defective pixel”. In this embodiment, the position of the phase defective pixel is stored as the phase defect correction data in the grid correction data storing unit 63. It should be noted that causes of the phase defective pixel are not limited to the void and dust, and there may be various causes relating to the structure and production, such as joint between the gratings, inclination of the grating patterns, etc.

Specifically, based on the pixel signals of the (fringe) images Dp(k=0 to M−1) for generating grid correction data taken in the state where the subject B is not present, an intensity-modulated signal with respect to the scanning step k is generated for each pixel, as shown in FIG. 17. Then, a pixel having an amplitude value of the intensity-modulated signal which does not exceed a predetermined threshold value is determined to be the phase defective pixel. It should be noted that the method to determine the phase defective pixel is not limited to the above-described method, and any other determination method may be used depending on various causes of the phase defective pixel.

Then, the phase contrast image generation unit 61 identifies the position of the defective pixel in the phase contrast image based on the phase defective pixel correction data stored in the grid correction data storing unit 63, and corrects the phase defective pixel with respect to the refraction angle ψ(x) , which is obtained as described above. A typical method to correct the phase defective pixel may involve generating a refraction angle φ of the phase defective pixel by linear interpolation from refraction angles cp of the surrounding normal pixels; however, any of various correction methods used for defective pixel correction with respect to the radiographic image detectors may be used. The phase defective pixel correction may be conducted after the phase offset correction has been conducted.

The number of the fringe images for generating the grid correction data taken in the state where the subject is not present, as described above, is not necessarily the same as the number of the fringe images taken in the state where the subject is present. That is, the number of scanning steps to take the images for generating grid correction data may be reduced from the number of scanning steps k (k=0 to M−1) by skipping some of the scanning steps k, or may be increased by using a smaller scanning pitch.

Since the refraction angle φ(x) is a value corresponding to the differential value of the phase shift distribution Φ(x), as expressed by Expression (14) above, the phase shift distribution Φ(x) can be obtained by integrating the refraction angle φ(x) along the x-axis.

Although the y-coordinate of each pixel with respect to the y-direction is not taken into account in the above description, similar calculation may be carried out for each y-coordinate to obtain a two-dimensional distribution of refraction angle φ(x, y). In this case, a two-dimensional phase shift distribution Φ(x, y) can be obtained as the phase contrast image by integrating the two-dimensional distribution of refraction angle φ(x, y) along the x-axis.

Alternatively, the phase contrast image may be generated by integrating a two-dimensional distribution of amount of phase shifting Ψ(x, y) along the x-axis, in place of the two-dimensional distribution of refraction angle φ(x, y).

The two-dimensional distribution of refraction angle φ(x, y) and the two-dimensional distribution of amount of phase shifting Ψ(x, y) correspond to the differential value of the phase shift distribution Φ(x, y), and thus are called differential phase images. The differential phase image may be generated as the phase contrast image.

In this manner, the phase contrast image is generated by the phase contrast image generation unit 61 based on the plurality of fringe images and the grid correction data (S22).

Although the distance Z₂ from the first grating 2 to the second grating 3 is the Talbot interference distance in the radiographic phase-contrast imaging apparatus of the above-described embodiment, this is not intended to limit the invention. The first grating 2 may be adapted to project the incident radiation without diffracting the radiation. In this case, similar projection images passed through the first grating 2 can be obtained at any position behind the first grating 2, and therefore the distance Z₂ from the first grating 2 to the second grating 3 can be set irrespectively of the Talbot interference distance.

Specifically, both the first grating 2 and the second grating 3 are formed as absorption type (amplitude modulation type) gratings and are adapted to geometrically project the radiation passed through the slits irrespectively the Talbot interference effect. In more detail, by setting values of the interval d₁ of the first grating 2 and the interval d₂ of the second grating 3 sufficiently greater than the effective wavelength of the radiation applied from the radiation source 1, the most part of the applied radiation can travel straight and pass through the slits without being diffracted by the slits. For example, in the case of the radiation source with a tungsten target, the effective wavelength of the radiation is about 0.4 Å at a tube voltage of 50 kV. In this case, the most part of the radiation is geometrically projected without being diffracted by the slits by setting the interval d₁ of the first grating 2 and the interval d2 of the second grating 3 on the order of 1 μm to 10 μm.

It should be noted that the relationship between the grating pitch P₁ of the first grating 2 and the grating pitch P₂ of the second grating 3 is the same as that in the first embodiment.

In the radiographic phase-contrast imaging apparatus having the above-described configuration, the distance Z₂ between the first grating 2 and the second grating 3 can be set at a value that is shorter than the minimum Talbot interference distance when m=1 in Expression (6) above. That is, the value of the distance Z₂ is set in a range satisfying Expression (19) below:

$${Z}_{2} < \frac{{P}_{1} {P}_{2}}{λ} \qquad ( 19 )$$

In order to generate a high-contrast periodic pattern image, it is preferred that the members 22 of the first grating 2 and the members 32 of the second grating 3 completely shield (absorb) the radiation. However, even when the above-described material with high absorption property (such as gold or platinum) is used, no small part of the radiation is transmitted without being absorbed. Therefore, in order to increase the radiation shielding property, the thicknesses h₁ and h₂ of the members 22 and 32 may be made as thick as possible. The members 22 and 32 may shield 90% or more of the radiation applied thereto. For example, if the tube voltage of the radiation source 1 is 50 kV, the thicknesses h₁ and h₂ may be 100 μm more when the members 22 and 32 are made of gold (Au).

However, similarly to the above-described embodiment, there is the problem of so-called vignetting of the radiation, and thus there is a limitation on the thicknesses h₁ and h₂ of the members 22 of the first grating 2 and the members 32 of the second grating 3.

According to the radiographic phase-contrast imaging apparatus having the above-described configuration, the distance Z₂ between the first grating 2 and the second grating 3 can be made shorter than the Talbot interference distance. In this case, the imaging apparatus can be made thinner than the radiographic phase-contrast imaging apparatus of the above-described embodiment, which have to ensure a certain Talbot interference distance.

Although only the cassette unit 17 is moved without changing the position of the radiation source to carryout the magnification imaging in the breast imaging system of the above-described embodiment, the radiation source unit 15 may be moved in the same direction as the cassette unit 17 along with the movement of the cassette unit 17 in the above-described case where both the first grating 2 and the second grating 3 are formed as absorption type (amplitude modulation type) gratings and are adapted to geometrically project the radiation passed through the slits irrespectively of the Talbot interference effect.

Although the plurality of fringe image signals for generating the phase contrast image are obtained by carrying out the plurality of imaging operations with shifting (translating) the second grating 3 by the scanning mechanism 5 in the grid unit 16 in the above-described embodiment, there is another method where the plurality of fringe image signals can be obtained in a single imaging operation without shifting the second grating as in the above-described method.

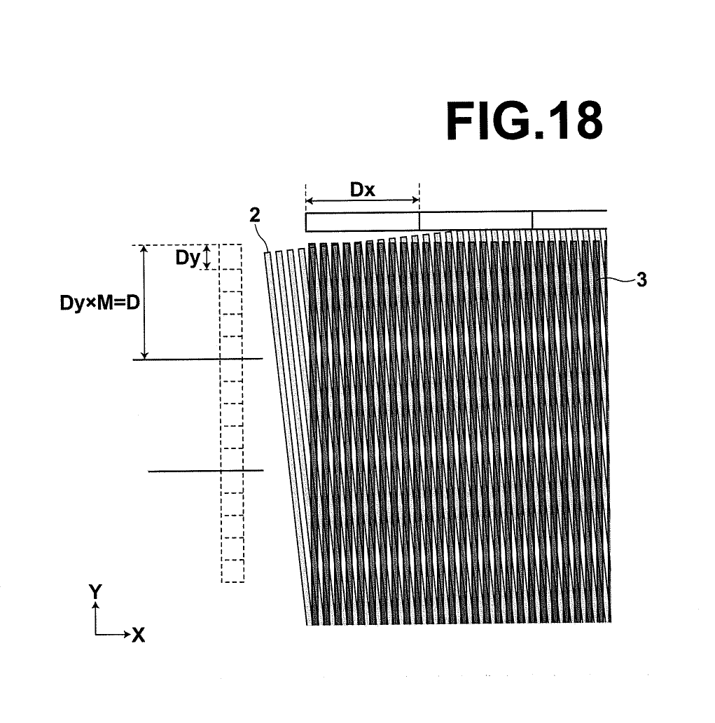

Specifically, as shown in FIG. 18, the first grating 2 and the second grating 3 are positioned such that the direction in which the first periodic pattern image of the first grating 2 extends is inclined relative to the direction in which the second grating 3 extends, such that the relationship as shown in FIG. 18 between a main-pixel size Dx in the main-scanning direction (the X-direction in FIG. 18) and a sub-pixel size Dy in the sub-scanning direction of each pixel of the image signal detected by the radiographic image detector 4 is achieved with respect to the thus positioned first grating 2 and third grating 3.

For example, in a case where the radiographic image detector is a radiographic image detector of a so-called optical reading system, which has a number of linear electrodes, where the image signal is read out by being scanned with a linear reading light source extending in a direction orthogonal to the direction in which the linear electrodes extend, the main-pixel size Dx is determined by the arrangement pitch of the linear electrodes of the radiographic image detector. In this case, the sub-pixel size Dy is determined by the width of linear reading light applied to the radiographic image detector in a direction in which the linear electrodes extend. In a case where a radiographic image detector of a so-called TFT reading system or a radiographic image detector using a CMOS sensor is used, the main-pixel size Dx is determined by the arrangement pitch of a pixel circuit in the arrangement direction of data electrodes, from which the image signal is read out, and the sub-pixel size Dy is determined by the arrangement pitch of the pixel circuit in the arrangement direction of gate electrodes, from which gate voltages are outputted.

Assuming that the number of the fringe images used to generate the phase contrast image is M, the first grating 2 is inclined relative to the second grating 3 such that Dy×M=D, where “Dy×M” represents M sub-pixel sizes Dy and “D” represents an image resolution in the sub-scanning direction of the phase contrast image.

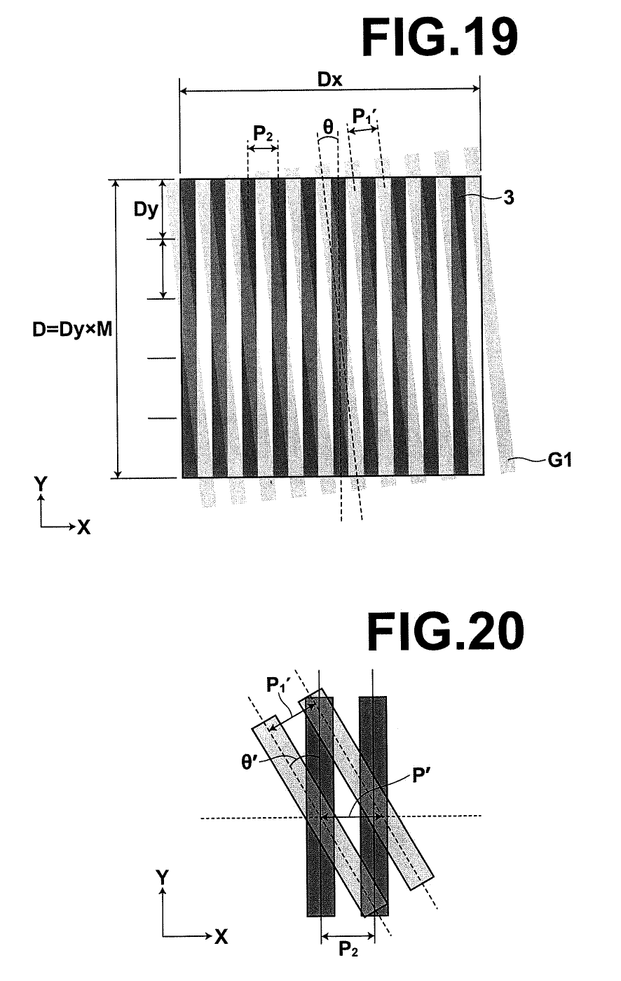

Specifically, as shown in FIG. 19, assuming that the pitch of the second grating 3 and the pitch of the self image G1 of the first grating 2 formed by the first grating 2 at the position of the second grating 3 is p₁′, a rotational angle in the X-Y plane of the self image G1 of the first grating 2 relative to the second grating 3 is e, and the image resolution in the sub-scanning direction of the phase contrast image is D (=Dy×M), then, the self image G1 of the first grating 2 deviates from the phase of the second grating 3 by an amount of n period(s) over the length of the image resolution D in the sub-scanning direction when the rotational angle θ is set to satisfy Expression (20) below (it should be noted that FIG. 17 shows a case where M=5 and n=1):

$$θ = arc tan \{ n \times \frac{{P}_{1}^{′}}{D} \} \qquad ( 20 )$$

where n is an integer other than 0 and a multiple of M.

Therefore, an image signal corresponding to a fraction of an intensity modulation for n period(s) of the self image G1 of the first grating 2 divided by M can be detected by each pixel having the size Dx×Dy, which corresponds to the image resolution D in the sub-scanning direction of the phase contrast image divided by M. Since n=1 in the example shown in FIG. 19, the self image G1 of the first grating 2 deviates from the phase of the second grating 3 by one period over the length of the image resolution D in the sub-scanning direction. Simply put, the range of the self image G1 of the first grating 2 passing through the second grating 3 for one period varies across the length of the image resolution D in the sub-scanning direction.

Then, since M=5 in this example, an image signal corresponding to a fraction of an intensity modulation for one period of the self image G1 of the first grating 2 divided by 5 can be detected by each pixel having the size Dx×Dy. That is, image signals of five different fringe images can be detected by the five pixels having the size Dx×Dy.

It should be noted that, since Dx=50 μm, Dy=10 μm and M=5 in this embodiment, as described above, the image resolution Dx in the main-scanning direction of the phase contrast image is the same as the image resolution D=Dy×M in the sub-scanning direction. However, it is not necessary that the image resolution Dx in the main-scanning direction and the image resolution D in the sub-scanning direction are the same, and they may have any main/sub ratio.

Although M=5 in this embodiment, M may be 3 or more, other than 5. Although n=1 in the above description, n may be any integer other than 0. That is, if n is a negative integer, the direction of the rotation is opposite from that in the above-described example. Further, n may be an integer other than ±1 to provide an intensity modulation for n periods. However, if n is a multiple of M, the same pattern is generated by the self image G1 of the first grating 2 and the phase of the second grating 3 among one set of M pixels having the size Dy in the sub-scanning direction, and it is impossible to obtain the M different fringe images. Therefore, n is other than a multiple of M.

Adjustment of the rotational angle θ of the self image G1 of the first grating 2 relative to the second grating 3 can be achieved, for example, by fixing a relative rotational angle between the radiographic image detector 4 and the second grating 3, and then rotating the first grating 2.

For example, assuming that p₁′=5 μm, D=50 μm and n=1 in Expression (18) above, a rotational angle θ is set to be about 5.7°. Then, an actual rotational angle θ′ of the self image G1 of the first grating 2 relative to the second grating 3 can be detected, for example, by a pitch of moire formed between the self image G1 of the first grating and the second grating 3.

Specifically, as shown in FIG. 20, assuming that the actual rotational angle is θ′ and an apparent pitch of the self image G1 in the X-direction after the rotation is P′, an observed moire pitch Pm is expressed as follows:

1/Pm=|1/P′−1/P₁′|.
Therefore, the actual rotational angle θ′ can be found by assigning:

P′=P₁′/cosθ′
to the above Expression. It should be noted that the moire pitch Pm may be found based on the image signals detected by the radiographic image detector 4.

Then, the actual rotational angle θ′ is compared with the rotational angle θ to be set which is derived from Expression (20), and the rotational angle of the first grating 2 may be adjusted automatically or manually by an amount corresponding to the difference between the actual rotational angle 0′ and the rotational angle θ to be set.

In the radiographic phase-contrast imaging apparatus having the above-described configuration, the image signals of a whole single frame read out from the radiographic image detector 4 are stored in the phase contrast image generation unit 61, and then, image signals of five different fringe images are obtained based on the stored image signals.

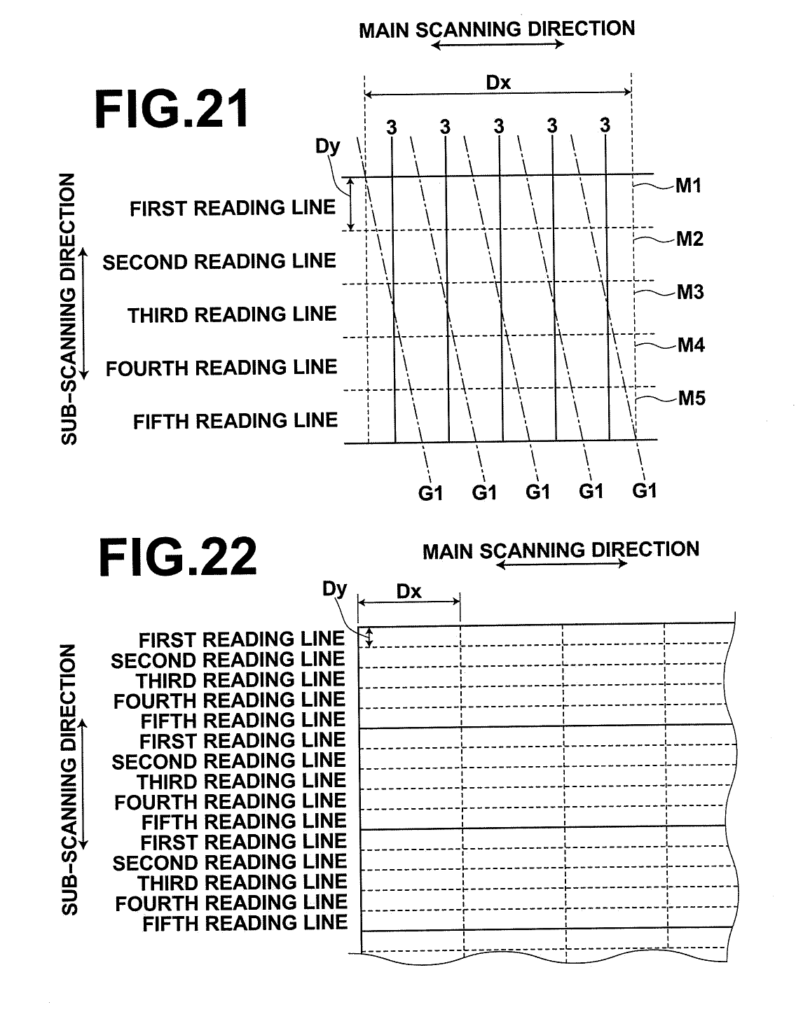

Specifically, in the case, as shown in FIG. 19, where the self image G1 of the first grating 2 is inclined relative to the second grating 3 such that the image resolution D in the sub-scanning direction of the phase contrast image is divided by 5 to detect image signals corresponding to fractions of the intensity modulation for one period of the self image G1 of the first grating 2 divided by 5, an image signal read out from the first reading line is obtained as a first fringe image signal M1, an image signal read out from the second reading line is obtained as a second fringe image signal M2, an image signal read out from the third reading line is obtained as a third fringe image signal M3, an image signal read out from the fourth reading line is obtained as a fourth fringe image signal M4 and an image signal read out from the fifth reading line is obtained as a fifth fringe image signal M5, as shown in FIG. 21. It should be noted that each of the first to fifth reading lines shown in FIG. 21 corresponds to the sub-pixel size Dy shown in FIG. 18.

Although FIG. 21 only shows a reading range of Dx×(Dy×5), the first to fifth fringe image signals are obtained in the same manner from the remaining reading range. Namely, as shown in FIG. 22, image signals of each pixel line group including pixel lines (reading lines) of every five pixels in the sub-scanning direction are obtained to obtain a single fringe image signal of a single frame. More specifically, image signals of the pixel line group of the first reading lines are obtained to obtain a first fringe image signal of a single frame, image signals of the pixel line group of the second reading lines are obtained to obtain a second fringe image signal of the single frame, image signals of the pixel line group of the third reading lines are obtained to obtain a third fringe image signal of the single frame, image signals of the pixel line group of the fourth reading lines are obtained to obtain a fourth fringe image signal of the single frame, and image signals of the pixel line group of the fifth reading lines are obtained to obtain a fifth fringe image signal of the single frame.

It should be noted that, also with respect to the grid correction data, five pieces of grid correction data are obtained in a single imaging operation in the same manner as the above-described imaging operation to take the phase contrast image.

Then, the phase contrast image generation unit 61 generates the phase contrast image based on the first to fifth fringe image signals and the five pieces of grid correction data.

Although, in the above description, the phase contrast image is generated with using the plurality of fringe image signals which are obtained by obtaining the image signals of the different pixel line groups from the single image, which is taken in the state where the first grating 2 and the second grating 3 are positioned such that the direction in which the self image G1 of the first grating 2 extends and the direction in which the second grating 3 extends are inclined relative to each other, as shown in FIG. 18, there is another usable method, which involves applying a Fourier transform to the single image taken as described above to generate the phase contrast image, without generating the fringe image signals based on the single image taken as described above.

Specifically, first, the Fourier transform is applied to the single image taken in the above-described state where the first grating 2 and the second grating 3 are positioned such that the direction in which the self image G1 of the first grating 2 extends and the direction in which the second grating 3 extends are inclined relative to each other, thereby separating absorption information and phase information which are influenced by the subject B contained in the image from each other.

Then, only the phase information influenced by the subject B in a frequency space is extracted and moved to the center (origin) position of the frequency space, and an inverse Fourier transform is applied to the extracted phase information. Then, the resulting imaginary part is divided by the real part for each pixel, and an arc tangent function (arctan (imaginary part/real part)) of the result of the division is calculated to find the refraction angle φ in Expression (18). Thus, the differential of the phase shift distribution in Expression (14), i.e., the differential phase image can be obtained.

Although the single image taken in the state where the first grating 2 and the second grating 3 are positioned such that the direction in which the self image G1 of the first grating 2 extends and the direction in which the second grating 3 extends are inclined relative to each other is used in the above-described method for generating the phase contrast image using the Fourier transform, this is not intended to limit the invention. For example, at least one image (fringe image) where moire, which is formed by superposing the self image G1 of the first grating 2 on the second grating 3, is detected may be used in the above-described method using the Fourier transform.

Now, the arrangement and operation of the above-described radiographic image detector of the optical reading system are described.

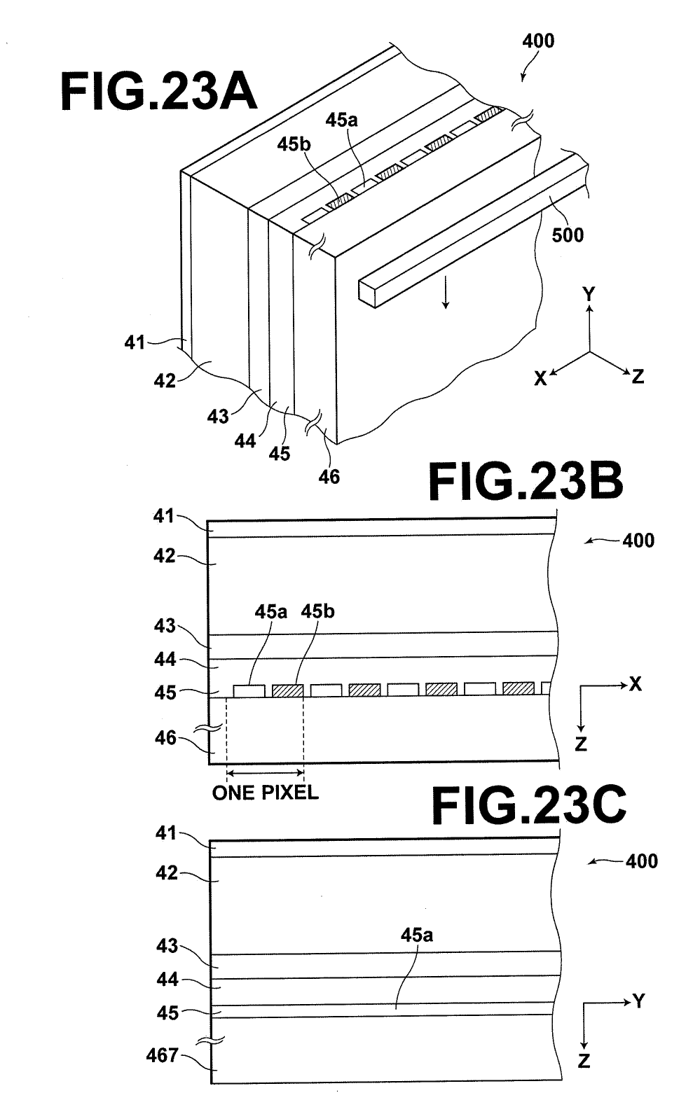

In FIG. 23, a perspective view of a radiographic image detector 400 of an optical reading system is shown at “A”, a sectional view of the radiographic image detector shown at A taken along the XZ-plane is shown at “B”, and a sectional view of the radiographic image detector shown at A taken along the YZ-plane is shown at “C”.

As shown at A to C in FIG. 23, the radiographic image detector 400 includes: a first electrode layer 41 that transmits radiation; a recording photoconductive layer 42 that generates electric charges when exposed to the radiation transmitted through the first electrode layer 41; an electric charge storing layer 43 that acts as an insulator against the electric charges of one of the polarities generated at the recording photoconductive layer 42 and acts as an conductor for the electric charges of the other of the polarities generated at the recording photoconductive layer 42; a reading photoconductive layer 44 that generates electric charges when exposed to reading light; and a second electrode layer 45, which are formed in layers on a glass substrate 46 in this order, where the second electrode layer 45 is formed on the glass substrate 46.

The first electrode layer 41 is made of a material that transmits radiation. Examples of the usable material may include MESA film (SnO₂), ITO (Indium Tin Oxide), IZO (Indium Zinc Oxide), and IDIXO (Idemitsu Indium X-metal Oxide, available from Idemitsu Kosan Co., Ltd.) which is an amorphous light-transmitting oxide film. The thickness of the first electrode layer 41 is in the range from 50 to 200 nm. As other examples, Al or Au with a thickness of 100 nm may be used.

The recording photoconductive layer 42 may be made of a material that generates electric charges when exposed to radiation. In view of relatively high quantum efficiency with respect to radiation and high dark resistance, a material mainly composed of a-Se is used. An appropriate thickness of the recording photoconductive layer 42 is in the range from 10 μm to 1500 μm. For mammography, in particular, the thickness of the recording photoconductive layer 42 may be in the range from 150 μm to 250 μm. For general imaging, the thickness of the recording photoconductive layer 42 may be in the range from 500 μm to 1200 μm.

The electric charge storing layer 43 is a film that insulates the electric charges of a polarity intended to be stored. Examples of the material forming the electric charge storing layer 43 may include: polymers, such as an acrylic organic resin, polyimide, BCB, PVA, acryl, polyethylene, polycarbonate and polyetherimide; sulfides, such as As₂S₃, Sb₂S₃ and ZnS; oxides; and fluorides. Optionally, the material forming the electric charge storing layer 43 insulates the electric charges of a polarity intended to be stored and conducts the electric charges of the opposite polarity. Further optionally, such a material that a product of mobility×life varies by as much as three digits or more depending on the polarity of the electric charges may be used.

Examples of compounds may include: As₂Se₃; As₂Se₃ doped with 500 ppm to 20000 ppm of Cl, Br or I; As₂(SeₓTe₁₋ₓ)₃ (where 0.5<x<1) provided by substituting about 50% of Se of As₂Se₃ with Te; a compound provided by substituting about 50% of Se of As₂Se₃ with S; AsₓSe_{y} (where x+y=100, 34≦x≦46) provided by changing the As concentration of As₂Se₃ by about ±15%; and an amorphous Se—Te where the Te content is 5 to 30 wt %.

In the case where such a material containing a chalcogenide element is used, the thickness of the electric charge storing layer may be in the range from 0.4 μm to 3.0 μm, or may optionally be in the range from 0.5 μm to 2.0 μm. The above-described electric charge storing layer may be formed at once or by stacking two or more layers.

The material forming the electric charge storing layer 43 may have a permittivity in the range from a half to twice of the permittivity of the recording photoconductive layer 42 and the reading photoconductive layer 44 so that a straight line of electric force formed between the first electrode layer 41 and the second electrode layer 45 is maintained.

The reading photoconductive layer 44 is made of a material that becomes conductive when exposed to the reading light. Examples of the material forming the reading photoconductive layer 44 may include photoconductive materials mainly composed of at least one of a-Se, Se—Te, Se—As—Te, metal-free phthalocyanine, metal phthalocyanine, MgPc (Magnesium phthalocyanine), VoPc (phase II of Vanadyl phthalocyanine) , CuPc (Copper phthalocyanine), etc. The thickness of the reading photoconductive layer 44 may be in the range from about 5 to about 20 μm.

The second electrode layer 45 includes a plurality of transparent linear electrodes 45a that transmit the reading light and a plurality of light-shielding linear electrodes 45b that shield the reading light. The transparent linear electrodes 45a and light-shielding linear electrodes 45b continuously extend from one end to the other end of an imaging area of the radiographic image detector 400 in straight lines. As shown at A and B in FIG. 23, the transparent linear electrodes 45a and the light-shielding linear electrodes 45b are alternately arranged at a predetermined interval.

The transparent linear electrodes 45a are made of a material that transmits the reading light and is electrically conductive. For example, similarly to the first electrode layer 41, the transparent linear electrodes 45a may be made of ITO, IZO or IDIXO. The thickness of the transparent linear electrodes 45a is in the range from about 100 to about 200 nm.

The light-shielding linear electrodes 45b are made of a material that shields the reading light and is electrically conductive. For example, the light-shielding linear electrodes 45b may be formed by a combination of the above-described transparent electrically conducting material and a color filter. The thickness of the transparent electrically conducting material is in the range from about 100 to about 200 nm.

In the radiographic image detector 400, one set of the transparent linear electrode 45a and the light-shielding linear electrode 45b adjacent to each other is used to read out an image signal, as described in detail later. Namely, as shown at B in FIG. 23, one set of the transparent linear electrode 45a and the light-shielding linear electrode 45b reads out an image signal of one pixel. For example, the transparent linear electrodes 45a and the light-shielding linear electrodes 45b may be arranged such that one pixel is substantially 50 μm.

As shown at A in FIG. 23, the radiographic image detector 400 also includes a linear reading light source 500, which extends in a direction (the X-direction) orthogonal to the direction along which the transparent linear electrodes 45a and the light-shielding linear electrodes 45b extend. The linear reading light source 500 is formed by a light source, such as LED (Light Emitting Diode) or LD (Laser Diode), and a predetermined optical system, and is adapted to apply linear reading light having a width of substantially 10 μm in the Y-direction to the radiographic image detector 400. The linear reading light source 500 is moved by a predetermined moving mechanism (not shown) relative to the Y-direction. As the linear reading light source 500 is moved in this manner, the linear reading light emitted from the linear reading light source 500 scans the radiographic image detector 400 to read out the image signals.

Next, operation of the radiographic image detector 400 having the above-described configuration is described.

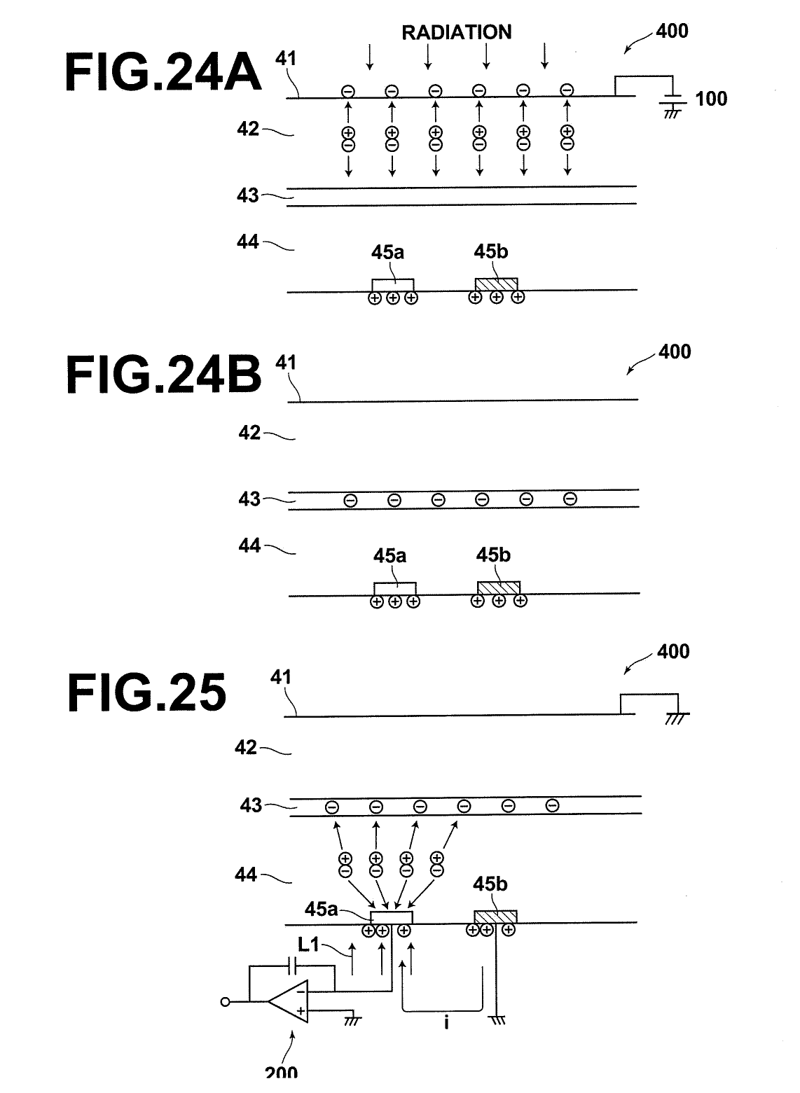

First, as shown at “A” in FIG. 24, in a state where a high-voltage power supply 100 applies a negative voltage to the first electrode layer 41 of the radiographic image detector 400, the radiation with the intensity thereof modulated by superposing the self image G1 of the first grating 2 on the second grating 3 is applied to the radiographic image detector 400 from the first electrode layer 41 side thereof.

Then, the radiation applied to the radiographic image detector 400 is transmitted through the first electrode layer 41 to be applied to the recording photoconductive layer 42. The application of the radiation causes generation of electric charge pairs at the recording photoconductive layer 42. Among the generated electric charge pairs, positive electric charges are combined with negative electric charges charged in the first electrode layer 41 and disappear, and negative electric charges are stored as latent image electric charges in the electric charge storing layer 43 (see “B” in FIG. 24).

Then, as shown in FIG. 25, in a state where the first electrode layer 41 is grounded, linear reading light L1 emitted from the linear reading light source 500 is applied to the radiographic image detector 400 from the second electrode layer 45 side thereof. The reading light L1 is transmitted through the transparent linear electrodes 45a to be applied to the reading photoconductive layer 44. Positive electric charges generated at the reading photoconductive layer 44 by the application of the reading light L1 are combined with the latent image electric charges stored in the electric charge storing layer 43. Negative electric charges generated at the reading photoconductive layer 44 by the application of the reading light L1 are combined with positive electric charges charged in the light-shielding linear electrodes 45b via a charge amplifier 200 connected to the transparent linear electrodes 45a.

When the negative electric charges generated at the reading photoconductive layer 44 are combined with the positive electric charges charged in the light-shielding linear electrodes 45b, electric currents flow to the charge amplifier 200, and the electric currents are integrated and detected as an image signal.

As the linear reading light source 500 is moved along the sub-scanning direction (the Y-direction), the linear reading light L1 scans the radiographic image detector 400. Then, for each reading line exposed to the linear reading light L1, the image signals are sequentially detected by the above-described operation, and the detected image signals of each reading line are sequentially inputted to and stored in the phase contrast image generation unit 61.

In this manner, the entire surface of the radiographic image detector 400 is scanned by the reading light L1, and the image signals of a whole single frame are stored in the phase contrast image generation unit 61.

Although the example where the radiographic phase-contrast imaging apparatus of the invention is applied to the breast imaging and display system has been described in the above-described embodiment, this is not intended to limit the invention. The radiographic phase-contrast imaging apparatus of the invention is also applicable to a radiographic imaging system that images a subject in the upright position, a radiographic imaging system that images a subject in the supine position, a radiographic imaging system that can image a subject in the standing position and the supine position, a radiographic imaging system that carries out long-length imaging, etc.

The present invention is also applicable to a radiographic phase-contrast CT apparatus that obtains a three-dimensional image, a stereo imaging apparatus that obtains a stereo image which can be stereoscopically viewed, etc.

The above-described embodiment provides an image which has conventionally been difficult to be depicted by obtaining a phase contrast image. Since conventional X-ray radiodiagnostics are based on absorption images, referencing an absorption image together with a corresponding phase contrast image can help image interpretation. For example, it is effective that a part of a body site which cannot be depicted in the absorption image is supplemented with image information of the phase contrast image by superposing the absorption image and the phase contrast image one on the other through suitable processing, such as weighting, tone processing or frequency processing.

However, if the absorption image is taken separately from the phase contrast image, it is difficult to successfully superpose the absorption image and the phase contrast image one on the other due to positional change of the subject body part between an imaging operation to take the phase contrast image and an imaging operation to take the absorption image, and the number of imaging operations increases, which increases the burden on the subject. Further, in recent years, small-angle scattering images are drawing attention, besides the phase contrast images and the absorption images. The small-angle scattering image can depict tissue characteristics attributed to a minute structure in a subject tissue, and is expected to be a depiction method for new imaging diagnosis in the fields of cancers and cardiovascular diseases, for example.

To this end, the computer 30 may further include an absorption image generation unit for generating an absorption image from the fringe images subjected to the cassette correction, which are obtained for generating the phase contrast image, and a small-angle scattering image generation unit for generating a small-angle scattering image from the fringe images subjected to the cassette correction.

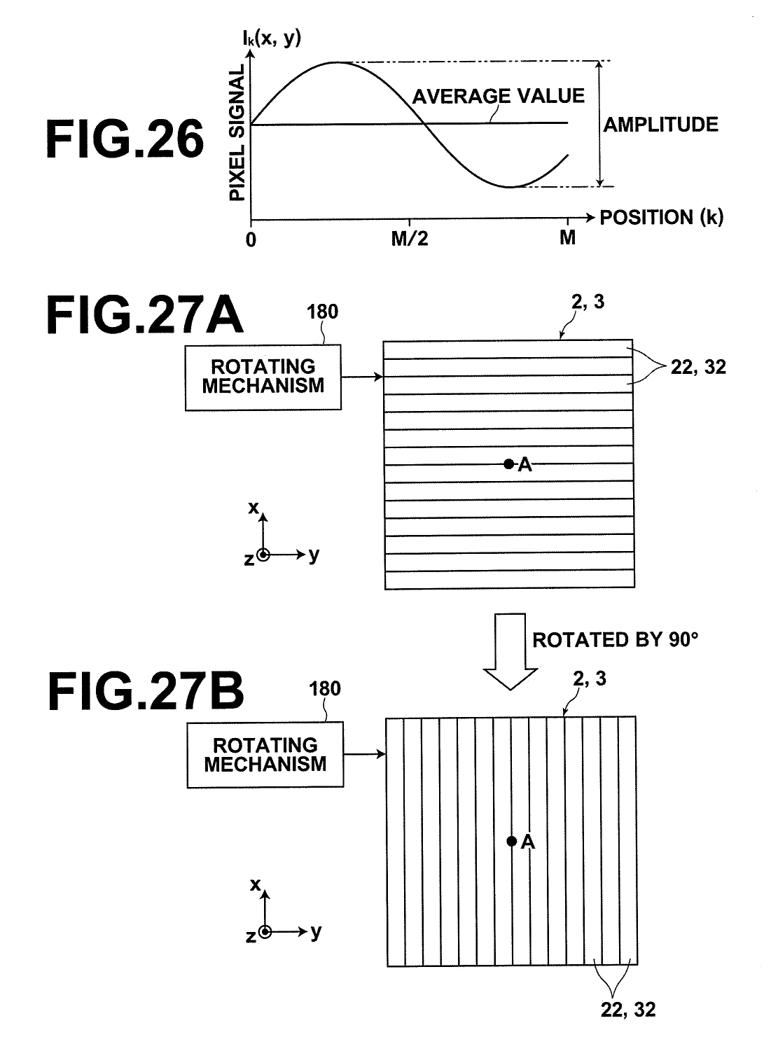

The absorption image generation unit generates the absorption image by averaging pixel signals Ik(x, y), which are obtained for each pixel, with respect to k, as shown in FIG. 26, to calculate an average value for each pixel to form an image. The calculation of the average value may be achieved by simply averaging the pixel signals Ik(x, y) with respect to k. However, since a large error occurs when M is small, the pixel signals Ik(x, y) may be fitted by a sinusoidal wave, and then an average value of the fitted sinusoidal wave may be calculated. Besides a sinusoidal wave, a square wave form or a triangular wave form may be used.

The method used to generate the absorption image is not limited to one using the average value, and any other value corresponding to the average value, such as an addition value calculated by adding up the pixel signals Ik(x, y) with respect to k, may be used.

The small-angle scattering image generation unit generates the small-angle scattering image by calculating an amplitude value of the pixel signals Ik(x, y) obtained for each pixel to form an image. The calculation of the amplitude value may be achieved by calculating a difference between the maximum value and the minimum value of the pixel signals Ik(x, y). However, since a large error occurs when M is small, the pixel signals Ik(x, y) may be fitted by a sinusoidal wave, and then an amplitude value of the fitted sinusoidal wave may be calculated. The method used to generate the small-angle scattering image is not limited to one using the amplitude value, and any other value corresponding to a variation relative to the average value, such as a variance value or a standard deviation, may be used.

Further, the phase contrast image is based on refracted components of the X-ray in the direction (the X-direction) in which the members 22 and 32 of the first and second gratings 2 and 3 are periodically arranged, and does not reflect refracted components in the direction (the Y-direction) in which the members 22 and 32 extend. That is, a contour of a body site along a direction intersecting with the X-direction (the Y-direction if the direction is orthogonal to the X-direction) is depicted in a phase contrast image based on the refracted components in the X-direction, and a contour of the body site along the X-direction, which dose not intersect with the X-direction, is not depicted in the phase contrast image in the X-direction. That is, there is a body site which cannot be depicted depending on the shape and orientation of the body site, which is a subject B. For example, it is believed that, when the direction of a plane of loading of an articular cartilage of the knee, or the like, is aligned with the Y-direction among the X- and Y-directions in the plane of the grating, a contour of the body site in the vicinity of the plane of loading (the YZ-plane) almost along the Y-direction is sufficiently depicted, but tissues (such as tendon and ligament) around the cartilage extending almost along the X-direction and intersecting with the plane of loading are depicted insufficiently. Although it is possible to retake the image of the insufficiently depicted body site with moving the subject B, this increases the burden on the subject B and the operator, and it is difficult to ensure positional repeatability between the image taken first and the image retaken next.

In order to address this problem, another preferred example is shown in FIG. 27, where a rotating mechanism 180 for rotating the first and second gratings 2 and 3 is provided in the grid unit 16. The rotating mechanism 180 rotates the first and second gratings 2 and 3 by an arbitrary angle from a first orientation, as shown at “a” in FIG. 27, around an imaginary line (the optical axis A of the X-ray) orthogonal to the center of the plane of the first and second gratings 2 and 3 into a second orientation as shown at “b” in FIG. 27, so that phase contrast images with respect to the first orientation and in the second orientation are generated.

In this manner, the above-described problem of positional repeatability can be solved. It should be noted that, although the orientation shown at “a” in FIG. 27 is the first orientation of the first and second gratings 2 and 3 where the members 32 of the second grating 3 extend along the Y-direction, and the orientation shown at “b” in FIG. 27 is the second orientation of the first and second gratings 2 and 3 where the first and second gratings 2 and 3 are rotated by 90° from the state shown at “a” in FIG. 27 such that the members 32 of the second grating 3 extend along the X-direction, the rotational angle of the first and second gratings 2 and 3 may be any angle as long as the relative inclination between the first grating 2 and the second grating 3 is maintained. Further, the rotating operation may be performed twice or more to generate the phase contrast images with respect to a third orientation, a fourth orientation, and the like, in addition to the first orientation and the second orientation.

It should be noted that the grid correction data is obtained for each rotational angle.

Still further, rather than rotating the first and second gratings 2 and 3 which are one-dimensional gratings, as described above, the first and second gratings 2 and 3 may be formed as two-dimensional gratings, where the members 22 and 32 extend in two-dimensional directions, respectively.

Comparing this configuration with the configuration where the one-dimensional gratings are rotated, this configuration provides phase contrast images corresponding to first and second directions in a single imaging operation, and thus the phase contrast images are not influenced by body motion of the subject and vibration of the apparatus between imaging operations and good positional repeatability is ensured between the phase contrast images corresponding to the first and second directions. Further, by eliminating the rotating mechanism, simplification and cost reduction of the apparatus can be achieved.

What is claimed is:

1. A radiographic imaging apparatus comprising:
a first grating having a periodically arranged grating structure and allowing radiation emitted from a radiation source to pass therethrough to form a first periodic pattern image;
a second grating having a periodically arranged grating structure to receive the first periodic pattern image and form a second periodic pattern image;
a radiographic image detector to detect the second periodic pattern image formed by the second grating;
a correction data storing unit to separately store detector correction data used to correct for characteristics of the radiographic image detector and grating correction data used to correct for characteristics of the first and second gratings;
a correction data updating unit to update the detector correction data and the grating correction data stored in the correction data storing unit independently from each other; and
an image generation unit to generate an image based on the detector correction data and the grating correction data updated by the correction data updating unit and the second periodic pattern image.

2. The radiographic imaging apparatus as claimed in claim 1, wherein
the radiographic image detector is adapted to be removable,
the apparatus further comprises a detector removal/attachment detection unit to detect removal and attachment of the radiographic image detector, and
the correction data updating unit updates the detector correction data when removal and attachment of the radiographic image detector are detected.

3. The radiographic imaging apparatus as claimed in claim 1, wherein
the first and second gratings are adapted to be removable,
the apparatus further comprises a grating removal/attachment detection unit to detect removal and attachment of the first and second gratings, and
the correction data updating unit updates the grating correction data when removal and attachment of the first and second gratings are detected.

4. The radiographic imaging apparatus as claimed in claim 1, wherein
the radiographic image detector and the first and second gratings are adapted to be removable,
the apparatus further comprises a detector removal/attachment detection unit to detect removal and attachment of the radiographic image detector and a grating removal/attachment detection unit to detect removal and attachment of the first and second gratings,
in a case where removal and attachment of only the radiographic image detector among the radiographic image detector and the first and second gratings are detected, the correction data updating unit updates only the detector correction data among the detector correction data and the grating correction data, and
in a case where removal and attachment of only the first and second gratings among the radiographic image detector and the first and second gratings are detected, the correction data updating unit updates only the grating correction data among the detector correction data and the grating correction data.

5. The radiographic imaging apparatus as claimed in claim 1, further comprising a moving mechanism to move the radiographic image detector in directions of relative movement toward and away from a subject,
wherein the correction data updating unit updates the grating correction data when the radiographic image detector is moved by the moving mechanism.

6. The radiographic imaging apparatus as claimed in claim 1, wherein
the radiographic image detector and the first and second gratings are adapted to be removable,
the apparatus further comprises a detector removal/attachment detection unit to detect removal and attachment of the radiographic image detector, a grating removal/attachment detection unit to detect removal and attachment of the first and second gratings, and a moving mechanism to move the radiographic image detector in directions of relative movement toward and away from a subject,
wherein:
in a case where removal and attachment of only the first and second gratings among the radiographic image detector and the first and second gratings are detected, the correction data updating unit updates only the grating correction data among the detector correction data and the grating correction data;
in a case where removal and attachment of only the radiographic image detector among the radiographic image detector and the first and second gratings are detected and the radiographic image detector is not moved by the moving mechanism, the correction data updating unit updates only the detector correction data among the detector correction data and the grating correction data; and
in a case where removal and attachment of only the radiographic image detector among the radiographic image detector and the first and second gratings are detected and the radiographic image detector is moved by the moving mechanism, the correction data updating unit updates both the detector correction data and the grating correction data.

7. The radiographic imaging apparatus as claimed in claim 1, wherein the detector correction data comprises at least one of offset correction data, sensitivity correction data and defective pixel correction data with respect to the radiographic image detector.

8. The radiographic imaging apparatus as claimed in claim 1, wherein the grating correction data is based on the second periodic pattern image detected by the radiographic image detector in a state where no subject is placed.

9. The radiographic imaging apparatus as claimed in claim 8, wherein the grating correction data is based on the second periodic pattern image subjected to offset correction with respect to the radiographic image detector.

10. The radiographic imaging apparatus as claimed in claim 8, wherein the grating correction data is based on the second periodic pattern image subjected to sensitivity correction with respect to the radiographic image detector.

11. The radiographic imaging apparatus as claimed in claim 8, wherein the grating correction data comprises defect position information of the first and second gratings.

12. The radiographic imaging apparatus as claimed in claim 1, further comprising
a scanning mechanism to move at least one of the first grating and the second grating in a direction orthogonal to a direction in which the one of the gratings extends,
wherein the image generation unit applies correction using the detector correction data to a plurality of radiographic image signals representing the second periodic pattern images detected by the radiographic image detector for different positions of the one of the gratings moved by the scanning mechanism, and generates a phase contrast image with using the corrected radiographic image signals and the grating correction data.

13. The radiographic imaging apparatus as claimed in claim 1, wherein
the first grating and the second grating are positioned such that a direction in which the first periodic pattern image of the first grating extends is inclined relative to a direction in which the second grating extends, and
the image generation unit applies correction using the detector correction data to a radiographic image signal detected by the radiographic image detector when the radiation is applied to a subject, and generates a phase contrast image with using the corrected radiographic image signal and the grating correction data.

14. The radiographic imaging apparatus as claimed in claim 13, wherein the image generation unit obtains radiographic image signals read out from different groups of pixel lines as radiographic image signals of different fringe images based on a radiographic image signal detected by the radiographic image detector, and generates the phase contrast image based on the obtained radiographic image signals of the fringe images.

15. The radiographic imaging apparatus as claimed in claim 1, wherein the image generation unit applies a Fourier transform to a radiographic image signal detected by the radiographic image detector when the radiation is applied to a subject, and generates a phase contrast image based on a result of the Fourier transform.

16. A radiographic image generation method of generating a radiographic image of a subject for use with a radiographic phase-contrast imaging apparatus including: a first grating having a periodically arranged grating structure and allowing radiation emitted from a radiation source to pass therethrough to form a first periodic pattern image; a second grating having a periodically arranged grating structure to receive the first periodic pattern image and form a second periodic pattern image; and a radiographic image detector to detect the second periodic pattern image formed by the second grating, the method comprising:
separately storing detector correction data used to correct for characteristics of the radiographic image detector and grating correction data used to correct for characteristics of the first and second gratings;
updating the detector correction data and the grating correction data independently from each other; and
generating an image based on the updated detector correction data and grating correction data and the second periodic pattern image.
